(19) United States
(12) Patent Application Publication
(10) Pub. No.: US 2021/0224795 A1
(43) Pub. Date: Jul. 22, 2021

(54) ESCROW NON-FACE-TO-FACE CRYPTOCURRENCY TRANSACTION DEVICE AND METHOD USING PHONE NUMBER

(71) Applicant: SWYCL INC., Seoul (KR)

(72) Inventors: Sung-Un SONG, Seoul (KR); Jin-Wook JUNG, Seoul (KR)

(73) Assignee: SWYCL INC., Seoul (KR)

(21) Appl. No.: 17/135,569

(22) Filed: Dec. 28, 2020

Related U.S. Application Data
(63) Continuation-in-part of application No. PCT/KR2019/007395, filed on Jun. 19, 2019.

(30) Foreign Application Priority Data
Jun. 29, 2018 (KR) 10-2018-0075873
Nov. 29, 2018 (KR) 10-2018-0150678

(51) Int. Cl. G06Q 20/36; G06Q 20/06; G06Q 20/02; G06Q 20/38

(52) U.S. Cl. CPC G06Q 20/3678; G06Q 20/065; G06Q 2220/00; G06Q 20/3829; G06Q 20/02

(57) ABSTRACT

An escrow non-face-to-face cryptocurrency transaction device and method using a phone number is proposed. The device and method includes: providing a phone number wallet that uses a phone number of a user as a login ID; using the phone number wallet having an electronic wallet address of a phone number system so as to remit and deposit cryptocurrency stored in the phone number wallet in an escrow virtual wallet of an escrow virtual wallet address generated for a one-time use in a one-time escrow virtual wallet; transmitting, to a remitter, escrow authentication information that enables a secure connection to the escrow virtual wallet and enables withdrawal authentication; and remitting the cryptocurrency deposited in the escrow virtual wallet address to an electronic wallet address of a recipient who inputs the escrow authentication information directly received from the remitter, so as to withdraw the cryptocurrency.

### CROSS-REFERENCE TO RELATED APPLICATIONS

The present application is a continuation-in-part of International Patent Application No. PCT/KR2019/007395 filed on Jun. 19, 2019, which is based upon and claims the benefit of priority to Korean Patent Application Nos. 10-2018-0075873 filed on Jun. 29, 2018, and 10-2018-0150678 filed on Nov. 29, 2018. The disclosures of the above-listed applications are hereby incorporated by reference herein in their entirety.

### TECHNICAL FIELD

The present invention relates to a cryptocurrency transaction device and method for cryptocurrency transaction and, more particularly, to an escrow non-face-to-face cryptocurrency transaction device and method using a phone number, the device and method including: providing a phone number wallet that uses a user's phone number as a login ID in an electronic wallet address, instead of using an anonymous electronic wallet address system that uses the electronic wallet address system such as identification (ID), authentication code, and a public key address in the form of a hash random number; remitting cryptocurrency stored in the phone number wallet and depositing the cryptocurrency to an escrow virtual wallet of an escrow virtual wallet address generated for a single use in the escrow virtual wallet by using an electronic wallet of a telephone number system (hereinafter referred to as “telephone number wallet”); transmitting escrow authentication information capable of securely accessing the escrow virtual wallet and authenticating withdrawal to a remitter, and remitting the cryptocurrency deposited in the escrow virtual wallet address to the electronic wallet address of a recipient who inputs the escrow authentication information.

### BACKGROUND ART

Recently, blockchain technology has been applied to information generated in various systems in various fields in order to increase security of the information, doing away from centralized information processing.

Usually, the blockchain is largely classified into types including: a public blockchain in which anyone is able to read and participate in a network to perform verification and approval; a private blockchain in which only authorized institutions are able to read and only approved agencies and supervisory institutions are able to perform the verification and approval; a consortium blockchain, etc.

As described above, because of distributing and using P2P resources for the purpose of decentralization, the public blockchain is verified, approved, and controlled by a blockchain system developer and all nodes (i.e., people and terminals) participating in a blockchain system without a central control and verification agency.

As a use case of such blockchains, decentralized cryptocurrency has emerged.

Cryptocurrency is issued, held, distributed, and incinerated for the purpose of transaction prices, verification, and participation rewards in the blockchain system.

Cryptocurrency includes: a coin issued on a Mainnet platform, which is commonly mentioned in the blockchain system; and a concept of DApp token, which is derived and issued while a subordinate service is provided on the basis of the Mainnet platform. In addition, cryptocurrency includes a concept of online virtual currency such as a coupon, a point, and cyber money, which are commonly mentioned in a broader sense.

Through an input of a password without going through identity verification, cryptocurrency also has anonymity by providing a private key and an electronic wallet address which is a hash-based public key.

When desiring to remit cryptocurrency, a remitter and a recipient should have an electronic wallet that has an encrypted electronic wallet address issued with anonymity, which is made up of various electronic wallet address systems, such as a public key in the form of a text whose identification is uncertain, the public key being a hash value of several tens of digits, numbers, English letters, special symbols, IDs, authentication codes, etc. The remitter and the recipient initiate remittance by inputting an encrypted electronic wallet address and a decrypted private key symmetrical to the encrypted electronic wallet address, inputting an amount of a coin (including a token), which is cryptocurrency to be remitted, that is, the coin amount (or “remittance amount”), and setting a certain amount of remittance fee or inputting the amount autonomously when necessary.

However, to the extent of an advantage of having anonymity, it is difficult for a remitter to clearly recognize whether the electronic wallet address belongs to the other party because an electronic wallet address has a random value and a long number of digits, and thus there is a problem in that cryptocurrency could be sent incorrectly to other people even if only one letter of the electronic wallet address was written incorrectly.

Due to the anonymity of the incorrectly sent cryptocurrency, it is impossible to know to whom the cryptocurrency was sent incorrectly in a system environment without the central control and authentication agency, and thus there in a problem in that collection of the incorrectly sent money is complicated.

In addition, for security purposes, one of the best methods is that a user memorizes a public key electronic wallet address and a private key, which are provided for a cryptocurrency transaction, but it may be very difficult for the user to memorize the electronic wallet address and private key belonging to the electronic wallet address system in which a combination of letters and numbers of random hash numbers are formed very long, as an example.

Due to the rapid development of the blockchain, an electronic wallet address system such as a simpler ID or authentication code is spread instead of a public key electronic wallet address, but is also based on anonymity, so there may occur an error in a transaction.

Therefore, users store the electronic wallet address and private key on a terminal, a memory device, a cloud drive, an e-mail, etc., which are not capable of communicating with the Internet, or the users print the electronic wallet address and private key on paper.

This measure is to protect against an illegal transaction or theft of cryptocurrency by avoiding the theft of the electronic wallet address and private key, caused by hacking in Internet communication conditions.

Although it is safe to store the electronic wallet address and private key separately through an off-line memory device or printout, which have no communication, there is still a problem in that a risk of loss or disappearance may occur.

Since cryptocurrency is frequently used for remittances between individuals and purchase payments for product purchases, it is necessary to protect an original electronic wallet address of a user, easily specify an electronic wallet address of the other party, and remit money easily. However, there are problems in that it is impossible for the user to easily identify the other party with the electronic wallet address of various systems provided in the existing cryptocurrency transaction system and also it is difficult for the user to remit and collect the money.

In addition, the cryptocurrency should be safely remitted only when the other party's identity is authenticated, but the existing cryptocurrency transaction system does not perform identity authentication of a recipient, so there is a problem in that it is difficult to verify that the recipient is the intended person.

### DISCLOSURE

### Technical Problem

Therefore, an objective of the present invention is to provide an escrow non-face-to-face cryptocurrency transaction device and method using a phone number, the device and method including: providing a phone number wallet that uses a user's phone number as a login ID in an electronic wallet address, instead of using an anonymous electronic wallet address system that uses the electronic wallet address system such as identification (ID), authentication code, and a public key address in the form of a hash random number; remitting cryptocurrency stored in the phone number wallet and depositing the cryptocurrency to an escrow virtual wallet of an escrow virtual wallet address generated for a single use in the escrow virtual wallet by using an electronic wallet of a telephone number system (hereinafter referred to as “telephone number wallet”); transmitting escrow authentication information capable of securely accessing the escrow virtual wallet and authenticating withdrawal to a remitter, and remitting the cryptocurrency deposited in the escrow virtual wallet address to the electronic wallet address of a recipient who inputs the escrow authentication information.

### Technical Solution

In order to achieve the objective of the present invention, there is provided an escrow non-face-to-face cryptocurrency transaction device using a phone number, the device including: an escrow server communication part that connects to a wired/wireless data communication network and performs data communication with other devices connected to the wired/wireless data communication network; an escrow server storage comprising a member DB that stores user's personal information including the phone number, a phone number wallet DB that stores a phone number wallet having a phone number wallet address issued by mapping to the phone number and manages cryptocurrency of a user in the phone number wallet by storing the cryptocurrency in an original electronic wallet address for each type of a corresponding cryptocurrency, and a temporary area that stores a one-time escrow virtual wallet having a one-time escrow virtual wallet address; and an escrow server controller that receives remittance information including a remitter's phone number and recipient's recipient information of a recipient from a remitter terminal, generates the escrow virtual wallet having the one-time escrow virtual wallet address to which recipient's personal information is applied, deposits the cryptocurrency corresponding to a remittance amount of the cryptocurrency of the remittance information from the phone number wallet corresponding to the phone number to the escrow virtual wallet, generates escrow authentication information including a one-time secure access path and a withdrawal authentication number, provides the secure access path and the withdrawal authentication number to the remitter terminal, compares a withdrawal authentication number received from a recipient terminal with a withdrawal authentication number previously set for the escrow virtual wallet corresponding to the secure access path when the secure access path, the withdrawal authentication number, and a recipient's electronic wallet address are input from the recipient terminal to receive the cryptocurrency, performs decrypted escrow authentication, and remits a cryptocurrency amount deposited in an escrow virtual wallet address to the recipient's electronic wallet address when the escrow authentication is successful.

The escrow server controller may include: a service event monitoring part that monitors whether a cryptocurrency escrow remittance service event occurs; a transaction type determination part that determines whether a recipient is a member according to an occurrence of the cryptocurrency escrow remittance service event, and a transaction type according to a service type between a remitter and the recipient; and a remittance processing part that receives the remittance information including the remitter's phone number and the recipient's recipient information from the remitter terminal according to the determined transaction type, generates the escrow virtual wallet having the escrow virtual wallet address to which the recipient's personal information is applied, performs a remittance deposit process in which the cryptocurrency corresponding to the remittance amount of the cryptocurrency of the remittance information is deposited by remitting the cryptocurrency from the phone number wallet corresponding to the phone number to the escrow virtual wallet address after generation of the escrow virtual wallet, generates the secure access path and the withdrawal authentication number after the remittance deposit process, performs a remittance process providing the secure access path and withdrawal authentication number to the remitter terminal, performs decryption authentication after comparing the withdrawal authentication number previously set for the escrow virtual wallet corresponding to the secure access path with the withdrawal authentication number received from the recipient terminal when the secure access path, the withdrawal authentication number, and the recipient's electronic wallet address are input from the recipient terminal to receive the cryptocurrency, and performs a withdrawal process by remitting the cryptocurrency amount deposited in the escrow virtual wallet to the recipient's electronic wallet address upon successful authentication.

The remittance processing part may include a real name transaction processing part between individual members, the real name transaction processing part generating the escrow virtual wallet having the escrow virtual wallet address to which a real name recipient code included in the recipient information of received remittance information is applied, performing the remittance deposit process when the transaction type is a real name transaction between individual members after the escrow virtual wallet is generated, generating the secure access path and the withdrawal authentication number and transmitting the secure access path and the withdrawal authentication number to the remitter terminal after a deposit process is performed, and performing the remittance process and the withdrawal process; a recipient identification transaction processing part performing the remittance deposit process and the remittance process when the transaction type is a recipient identification transaction among the real name transactions between individual members, requesting an application program login according to a recipient identification request when the recipient terminal accesses the escrow virtual wallet address during the withdrawal process, and then performing the escrow authentication by receiving the withdraw authentication number from a user terminal after recipient logs in as the member through the recipient terminal, and performing the withdrawal process of remitting the cryptocurrency amount deposited in the escrow virtual wallet address to the recipient's electronic wallet address when the escrow authentication is successful; an anonymous recipient transaction processing part performing the remittance deposit process by generating the escrow virtual wallet having the escrow virtual wallet address to which an anonymous recipient code included in the received remittance information is applied when the transaction type is an anonymous recipient transaction, and then performing the remittance processing and withdrawal processing after generating the secure access path and the withdrawal authentication number; and a purchase transaction processing part performing the remittance deposit process by generating the escrow virtual wallet with the escrow virtual wallet address applied with a real name seller code which is the real name recipient code included in seller information which is the recipient information of the received remittance information, when the transaction type is a product purchase transaction between a buyer and a seller, generating and temporarily storing the escrow authentication information including the secure access path and a payment verification number, writing a transaction detail confirmation form including the cryptocurrency amount deposited as a payment between the buyer as the remitter and the seller as the recipient, information on the transaction party, order information, and delivery check, temporarily storing the transaction detail confirmation form by using the escrow payment transaction number as an access code per case, respectively providing the escrow payment transaction numbers to the remitter's terminal and the recipient's terminal, confirming product delivery and product receipt according to the escrow payment transaction number, confirming receipt of product, approving payment upon access by the buyer by the escrow payment transaction number, performing the remittance process of transmitting the escrow authentication information only to the seller, and then performing the payment process.

The recipient identification transaction processing part may extract terminal identification information when the recipient requests to log in to a member application program, and may identify the recipient by comparing name, phone number, and terminal identification information of the recipient with name, phone number, and terminal identification information of member information for the recipient who has previously registered, so as to allow an access.

The escrow server controller may further include a service registration part obtaining terminal identification information including personal information and a user's phone number from the user who desires to subscribe to a cryptocurrency escrow remittance service, storing member information including the personal information and the terminal identification information in response to the phone number, generating the phone number wallet having the electronic wallet address issued by the phone number, newly issuing the original electronic wallet address and a private key for each coin type selected by the user for the phone number wallet or obtaining the original electronic wallet address and the private key which are input from an external cryptocurrency exchange, storing the original electronic wallet address and the private key after mapping with the phone number wallet address and a remittance password, and then registering the user as a member of the cryptocurrency escrow remittance service.

The service registration part may include: an authentication information acquisition part comprising a personal information acquisition part obtaining the personal information from a user terminal and a terminal identification information acquisition part for obtaining the terminal identification information including the phone number from the user terminal; an authentication processing part performing identity verification by at least one of the personal information and the terminal identification information through an external identity verification agency and storing a result of successful identity verification received from the external identity verification agency upon successful verification; and a service registration processing part storing the member information including the personal information and the terminal identification information in response to the phone number upon successful authentication through the authentication processing part, generating the phone number wallet having the phone number wallet address issued by the phone number, obtaining the original electronic wallet address for each coin type selected by the user for the phone number wallet by newly issuing or inputting the original electronic wallet address, storing the original electronic wallet address after mapping with the phone number wallet address and the remittance password, and then registering the user as the member of the escrow remittance service.

The authentication information acquisition part may further include an identity authentication information acquisition part obtaining and storing at least one of a user's personal identification number (PIN), biometric information, a one-time QR code, and alternative authentication identification information from the user terminal, wherein the escrow server controller may receive identity authentication information by the user terminal when the remitter or recipient logs in as the member, may perform identity authentication by comparing entered identity authentication information with stored identity authentication information, and may allow the user to log in when the identity authentication is successful.

The escrow server controller may transmit the cryptocurrency of the remittance amount deposited in the escrow virtual wallet to the recipient's electronic wallet address, and then may delete the escrow authentication information including the one-time escrow virtual wallet address, escrow virtual wallet information, the one-time secure access path, and the withdrawal authentication number.

In order to achieve the objective of the present invention, there is provided an escrow non-face-to-face cryptocurrency transaction method using a phone number, the method including: a cryptocurrency amount remittance deposit process, wherein an escrow server controller receives remittance information including a remitter's phone number and recipient's recipient information from a remitter terminal, generates an escrow virtual wallet having a one-time escrow virtual wallet address, remits and deposits cryptocurrency corresponding to a remittance amount of the cryptocurrency of the remittance information from a phone number wallet corresponding to the phone number to the one-time escrow virtual wallet address, and generates escrow authentication information including a one-time secure access path and a withdrawal authentication number; an escrow authentication information provision process, wherein the escrow server controller provides the escrow authentication information including the secure access path and the withdrawal authentication number to the remitter terminal; and a cryptocurrency withdrawal process, wherein, when the secure access path, the withdrawal authentication number, and a recipient's electronic wallet address from a recipient terminal to receive the cryptocurrency are input, the escrow server controller compares the withdrawal authentication number received from the recipient terminal with the withdrawal authentication number previously set for the one-time escrow virtual wallet corresponding to the secure access path, performs escrow authentication to decrypt the encrypted one-time escrow virtual wallet address with the withdrawal authentication number, and then remits the amount of the cryptocurrency deposited in the one-time escrow virtual wallet address to the recipient's electronic wallet address when escrow authentication is successful.

The cryptocurrency amount remittance deposit process may include: monitoring a service event, wherein the escrow server controller monitors whether a cryptocurrency escrow remittance service event occurs through a service event monitoring part; determining a transaction type, wherein the escrow server controller determines whether a recipient is a member according to an occurrence of the cryptocurrency escrow remittance service event and determines the transaction type according to a service type between a remitter and the recipient; receiving the remittance information, wherein, from the remitter terminal through a remittance processing part, the escrow server controller receives the remittance information including the remitter's phone number and recipient's recipient information according to the determined transaction type and the remittance amount to be remitted to an original electronic wallet address corresponding to the cryptocurrency to be remitted and the cryptocurrency; and depositing the cryptocurrency, wherein the escrow server controller generates the one-time escrow virtual wallet having the one-time escrow virtual wallet address through the remittance processing part, generates the one-time escrow virtual wallet, performs a deposit process of remitting the cryptocurrency corresponding to the remittance amount of the cryptocurrency of the remittance information from the original electronic wallet address corresponding to a coin to be remitted of the phone number wallet to the one-time escrow virtual wallet address, and then generates the escrow authentication information including the one-time secure access path and the withdrawal authentication number.

In the determining of the transaction type, the escrow server controller may determine any one of a real name transaction between individual members, a recipient identification transaction among the real name transactions between individual members, an anonymous recipient transaction, and a product purchase transaction, according to the remitter information and the recipient information of the received remittance information.

The cryptocurrency withdrawal process may include: processing the real name transaction between individual members, wherein, when the transaction type is the real name transaction between individual members, a real name transaction processing part between individual members generates the escrow virtual wallet having the escrow virtual wallet address applied with a real name recipient code included in the recipient information of the received remittance information, performs the remittance deposit process after generating the escrow virtual wallet, generates the secure access path and the withdrawal authentication number after performing the deposit process, transmits the secure access path and the withdrawal authentication number to the remitter terminal, and then performs the remittance process and withdrawal process; processing the recipient identification transaction, wherein when the transaction type is the recipient identification transaction among the real name transactions between individual members, the recipient identification transaction processing part performs the remittance deposit process and the remittance process, requests the application program log in according to the recipient identification request when the recipient terminal accesses the escrow virtual wallet address during performing the withdrawal process, receives a payment verification number from the user terminal after logging in as the member of the recipient through the recipient terminal, performs the escrow authentication, and then performs the withdrawal process of remitting a cryptocurrency amount deposited in the escrow virtual wallet address to the recipient's electronic wallet address when the escrow authentication is successful; processing the anonymous recipient transaction, wherein when the transaction type is the anonymous recipient transaction, the anonymous recipient transaction processing part performs the remittance deposit process by generating the escrow virtual wallet having the escrow virtual wallet address to which an anonymous recipient code included in the received remittance information is applied, generates the secure access path and the withdrawal authentication number, allows the recipient to directly input the electronic wallet address, and then performs the remittance process and withdrawal process; and processing the purchase transaction, wherein when the transaction type is the product purchase transaction between a buyer and a seller, a purchase transaction processing part performs the remittance deposit process by generating the escrow virtual wallet having the escrow virtual wallet address applied with a real name seller code which is the real name recipient code included in seller information which is the recipient information of the received remittance information, generates and temporarily stores the escrow authentication information including the secure access path and the withdrawal authentication number, writes a transaction detail confirmation form including the cryptocurrency amount deposited as a payment between the buyer as the remitter and the seller as the recipient, information on the transaction party, order information, and delivery check, etc., temporarily stores the transaction detail confirmation form by using an escrow payment transaction number as an access code per case, provides each escrow payment transaction number to the remitter's terminal and the recipient's terminal, confirms product delivery and product receipt according to the escrow payment transaction number, confirms receipt of product, approves the payment when the buyer accesses by the escrow payment transaction number, performs the remittance process in which the escrow authentication information is transmitted only to the seller, and then performs the withdrawal process.

The processing of the recipient identification transaction may include: requesting application program login, wherein, when the transaction type is the recipient identification transaction among the real name transactions between individual members, after performing the remittance deposit process and the remittance process, the recipient terminal requests application program login according to the recipient identification request when accessing the one-time escrow virtual wallet during performing the withdrawal process; identifying the recipient, wherein the terminal identification information of the recipient terminal is retrieved when the recipient logs in as the member through the recipient terminal, and the recipient is identified by comparing the obtained recipient's name, telephone number, and extracted terminal identification information with the name, telephone number, and terminal identification information of the recipient's member information; and withdrawing money, wherein, when the recipient is identified, the one-time withdrawal authentication number is received from the recipient terminal to perform the escrow authentication, and the amount of the cryptocurrency deposited in the one-time escrow virtual wallet address is remitted to the recipient's electronic wallet address when escrow authentication is successful.

The cryptocurrency withdrawal process may further include: deleting the escrow virtual wallet, wherein the escrow server controller deletes the escrow virtual wallet having the one-time escrow virtual wallet address after remitting the cryptocurrency deposited in the one-time escrow virtual wallet, and deletes the escrow authentication information including the one-time secure access path and the withdrawal authentication number.

### Advantageous Effects

In the present invention, since a single phone number wallet expressed with a user's own phone number may be used by combining and replacing one or more cryptocurrency electronic wallet addresses having anonymity of various systems such as IDs, authentication codes, and public keys in the form of a hash random number consisting of a combination of long letters and numbers, there is an effect of providing convenience to the user.

In addition, in the present invention, when mapping with phone number wallet addresses after obtaining original electronic wallet addresses including private keys, the private keys of various systems that are symmetric for passwords of the original electronic wallet addresses based on public keys are also replaced by remittance passwords, so the remittance passwords are input by the replacement without separately inputting the private keys symmetric to the original electronic wallet addresses issued by coin type each time remittance is made, thereby having an effect of minimizing use of the private keys, so as to provide convenience and security in the private key use.

In addition, the present invention has an effect of providing a real name that may reliably identify the other party by verifying the owner of a phone number wallet through an identity verification and identity authentication process.

In addition, the present invention has an effect of improving security by replacing an original electronic wallet address, such as a bank account number or a credit card number, with a replaced phone number wallet address.

In addition, the present invention has an effect of improving reliability of a transaction by reducing a transaction error and an illegal transaction during the cryptocurrency transaction through an escrow function.

### DESCRIPTION OF DRAWINGS

FIG. 1 is a view showing a configuration of an escrow non-face-to-face cryptocurrency transaction system including an escrow non-face-to-face cryptocurrency transaction device using a phone number according to the present invention.

FIG. 2 is a view conceptually showing a cryptocurrency remittance method in an escrow non-face-to-face cryptocurrency transaction method using a phone number according to an exemplary embodiment of the present invention.

FIG. 3 is a view conceptually showing an escrow deposit confirmation method among the escrow non-face-to-face cryptocurrency transaction methods using phone numbers according to the exemplary embodiment of the present invention.

FIG. 4 is a view conceptually showing an escrow withdrawal method in the escrow non-face-to-face cryptocurrency transaction system using a phone number according to the present invention.

FIG. 5 is a view showing a configuration of a user terminal of the escrow non-face-to-face cryptocurrency transaction system using a phone number according to the present invention.

FIG. 6 is a view showing a configuration of an escrow non-face-to-face cryptocurrency transaction device of the escrow non-face-to-face cryptocurrency transaction system using a phone number according to the present invention.

FIG. 7 is a view showing a configuration of a service registration part of an escrow server controller of the escrow non-face-to-face cryptocurrency transaction device in the escrow non-face-to-face cryptocurrency transaction system using a phone number according to the present invention.

FIG. 8 is a flowchart showing a service member subscription method among the escrow non-face-to-face cryptocurrency transaction methods using phone numbers according to the present invention.

FIGS. 9 and 10 are flowcharts showing the escrow non-face-to-face cryptocurrency transaction method using a phone number, the flowcharts showing an escrow remittance method according to a first exemplary embodiment of the present invention.

FIG. 11 is a flowchart showing an escrow remittance method according to a second exemplary embodiment of the escrow non-face-to-face cryptocurrency transaction method using a phone number of the present invention.

FIG. 12 is a flowchart showing the escrow non-face-to-face cryptocurrency transaction method using a telephone number and serving for a recipient identification transaction of the present invention.

FIG. 13 is a flowchart showing the escrow non-face-to-face cryptocurrency transaction method using a phone number according to an anonymous recipient transaction according to the present invention.

FIGS. 14 and 15 are flowcharts showing the escrow non-face-to-face cryptocurrency transaction method using a phone number according to product sales and purchase.

### BEST MODE

With reference to the accompanying drawings, an escrow non-face-to-face cryptocurrency transaction device using a phone number according to the present invention will be described for the configuration and operation thereof, and an escrow non-face-to-face cryptocurrency transaction method will be described in detail.

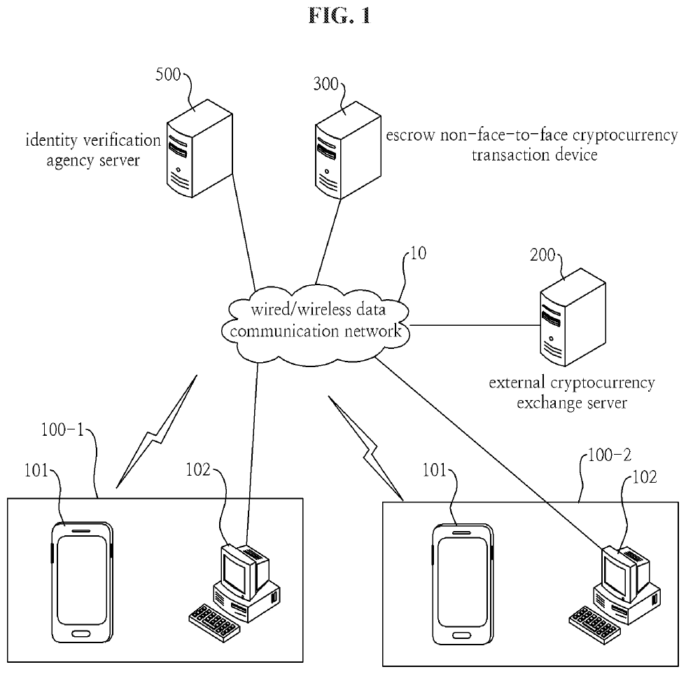

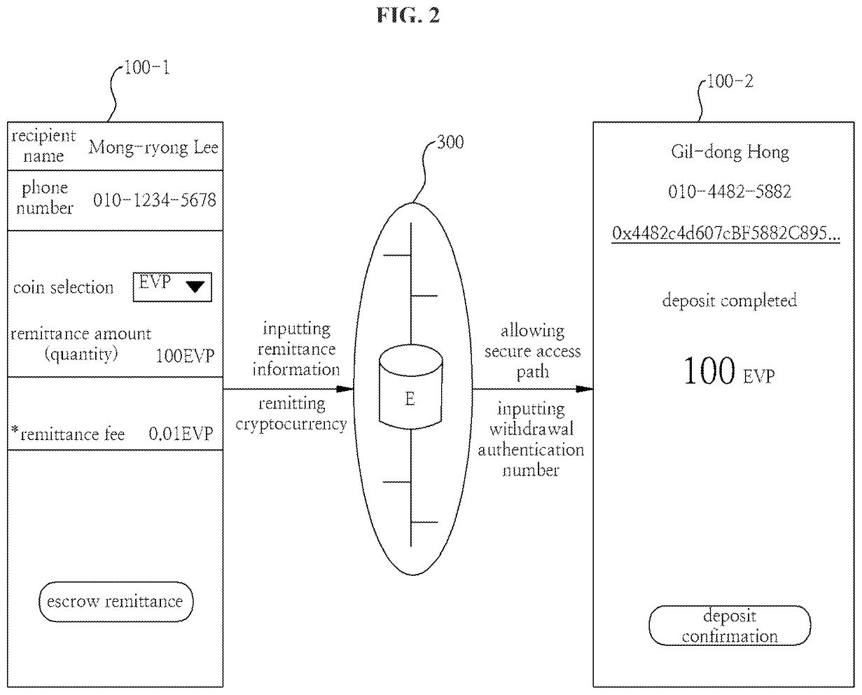

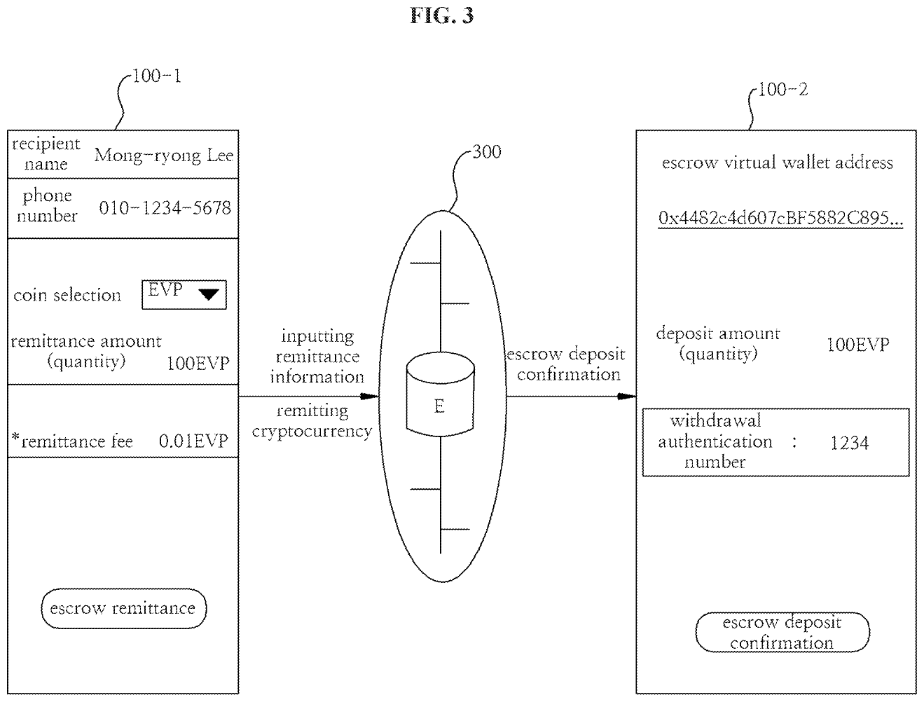

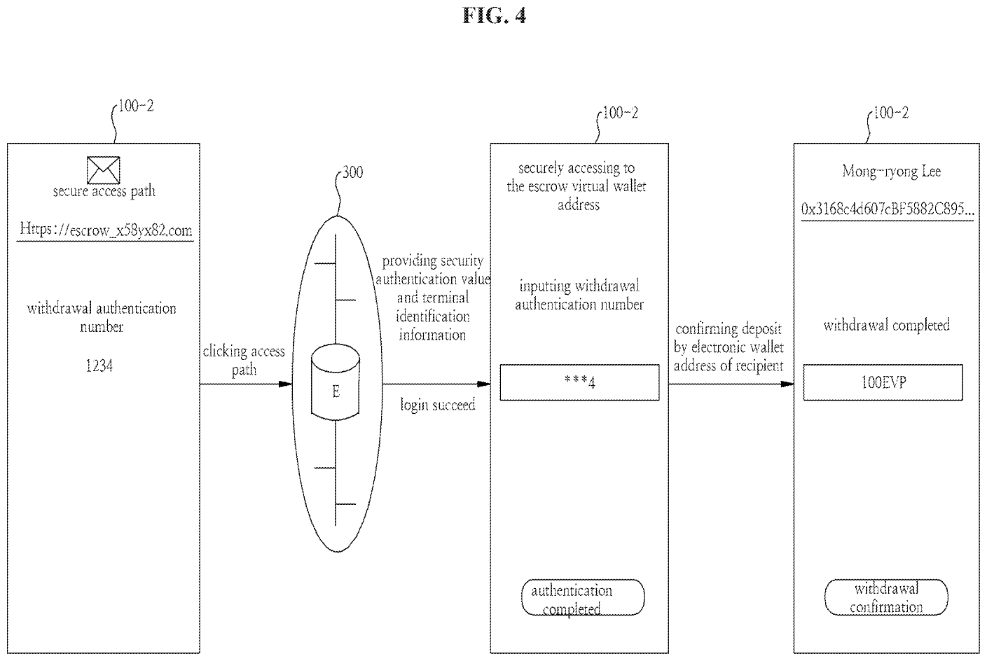

FIG. 1 is a view showing a configuration of an escrow non-face-to-face cryptocurrency transaction system including an escrow non-face-to-face cryptocurrency transaction device using a phone number according to the present invention, FIG. 2 is a view conceptually showing a cryptocurrency remittance method in an escrow non-face-to-face cryptocurrency transaction method using a phone number according to an exemplary embodiment of the present invention, FIG. 3 is a view conceptually showing an escrow deposit confirmation method in the escrow non-face-to-face cryptocurrency transaction method using phone numbers according to the exemplary embodiment of the present invention, and FIG. 4 is a view conceptually showing an escrow withdrawal method in the escrow non-face-to-face cryptocurrency transaction system using a phone number according to the present invention. Hereinafter, the present invention will be described with reference to FIGS. 1 to 4.

The escrow cryptocurrency transaction system using a phone number according to the present invention includes a user terminal 100 and an escrow non-face-to-face cryptocurrency transaction device 300, and according to an exemplary embodiment, may further include an external cryptocurrency exchange server 200 and an identity verification agency server 500.

The user terminal 100, the external cryptocurrency exchange server 200, the escrow non-face-to-face cryptocurrency transaction device 300, and the identity verification agency server 500 perform interconnective data communication by way of connecting to either wired or wireless network through a wired and wireless data communication network 10.

The wired and wireless data communication network 10 may be a communication network to which at least one or more of a wide area network (WAN) including a WiFi network and a local area network (LAN), a mobile communication network such as a second-generation cellular network (2G), 3G, 4G, and 5G, a WiBro network, a dedicated network, etc. are interconnected with each other.

The user terminal 100 is a terminal used by a member who has subscribed to an escrow remittance service according to the present invention and a recipient who receives cryptocurrency according to the escrow remittance service, and may be any one of a mobile terminal 101 such as a smartphone and a smart pad, and a computer terminal 102 such as a desktop computer and a notebook computer.

The user terminal 100 is referred to as a remitter terminal 100-1 when used as a user terminal 100 of a remitter who remits cryptocurrency, and is referred to as a recipient terminal 100-2 when used as a user terminal 100 of a recipient who receives the cryptocurrency.

In the case of a purchase transaction according to a transaction type, since the remitter may be a buyer who has purchased a certain product and the recipient may be a seller, the remitter terminal 100-1 may be defined as a buyer terminal 100-1, or the recipient terminal 100-2 may be defined as a seller terminal 100-2, according to the transaction type.

The remitter who is to remit cryptocurrency and the recipient who is the seller must be a member of the escrow remittance service according to the present invention, but the recipient may be a member or a non-member of the escrow remittance service, depending on the transaction type of the present invention.

When the recipient is the non-member of the escrow remittance service, the recipient must have a cryptocurrency electronic wallet in the external cryptocurrency exchange server 200.

The external cryptocurrency exchange server 200 has electronic wallets having cryptocurrency electronic wallet addresses for a number of members, and provides a means for selling and buying cryptocurrency among users who have the cryptocurrency, and provides functions of remitting and receiving the cryptocurrency according to the selling and buying of the cryptocurrency.

The identity verification agency server 500 is a server of an agency, such as a communication company, a card company, or an authentication agency, which are capable of performing identity verification, and upon receipt of identity verification request information including identity verification information from the escrow non-face-to-face cryptocurrency transaction device 300, the identity verification agency server 500 performs general identity verification and provides a result value of identification (i.e., duplicate registration confirmation information (Duplication Information: DI)) according to the identification result.

The escrow non-face-to-face cryptocurrency transaction device 300 registers a number of users as members of the escrow remittance service and as members of the seller, and stores phone number wallets that have phone number wallet addresses for registered members. When the escrow remittance service is requested by a certain remitter who is an escrow remittance service member, requesting remittance from the remittance terminal 100-1 to the recipient terminal 100-2, the escrow non-face-to-face cryptocurrency transaction device 300 generates an escrow virtual wallet having a one-time escrow virtual wallet address so as to deposit the cryptocurrency, corresponding to the remittance amount to be remitted, in the one-time escrow virtual wallet, and then transmits the escrow authentication information to the remitter terminal 100-1 by generating escrow authentication information including a secure access path and withdrawal authentication number for accessing the escrow virtual wallet.

When the remittance amount is deposited in the escrow virtual wallet, the escrow non-face-to-face cryptocurrency transaction device 300 accesses the escrow virtual wallet corresponding to the escrow virtual wallet address when receiving a request to access the escrow virtual wallet address including the secure access path from the recipient terminal 100-2 of the recipient, compares the previously stored withdrawal authentication number with a withdrawal authentication number when being input from the recipient terminal 100-2, and then remits the cryptocurrency, deposited in the escrow virtual wallet, to the electronic wallet of the recipient's cryptocurrency electronic wallet address when the escrow authentication in which the encrypted escrow virtual wallet address is decrypted is successful.

When the recipient is a member of the escrow remittance service and accordingly has a phone number wallet in the escrow non-face-to-face cryptocurrency transaction device 300, the recipient's electronic wallet is the phone number wallet. Whereas, when the recipient is not the member of the escrow remittance service or performs an anonymous transaction, the recipient's electronic wallet may be an electronic wallet of the external electronic wallet address of the external cryptocurrency exchange server 200. Naturally, even in the case of the member, the recipient's electronic wallet address may be the external electronic wallet address of the external cryptocurrency exchange server 200.

The external cryptocurrency exchange is referred to further include a service provider who provides services including an exchange function of cryptocurrency, or a wallet function of cryptocurrency and an electronic wallet issued not only by a unique exchange that acts as an intermediary for cryptocurrency transactions, but also by an issuing company that issues, holds, distributes, exchanges, and incinerates the cryptocurrency.

The escrow non-face-to-face cryptocurrency transaction device 300 may be configured as one single server, or may be configured to include one or more servers such as at least one or more servers for processing registration and login to services, at least one or more servers for managing cryptocurrency by coin type and performing remittance process, at least one or more servers for managing data such as a cryptocurrency transaction ledger, and at least one or more server for generating and temporarily storing an escrow wallet having a one-time escrow virtual wallet address. The number of these servers will be determined depending on traffic volumes and a number of uses such as service functions, data processing, security, communication, synchronization, etc.

The phone number wallet will receive and store a transaction ledger block of the cryptocurrency purchased by a user through a cryptocurrency purchase function provided by the escrow non-face-to-face cryptocurrency transaction device 300 or purchased through the external cryptocurrency exchange server 200. It may be preferable for the escrow non-face-to-face cryptocurrency transaction device 300 to make the transaction ledger for such a cryptocurrency transaction into a block file to distribute and store the block file across nodes of a blockchain network (not shown).

Referring to FIGS. 2 to 4, the remitter terminal 100-1 displays a user graphic interface means on a screen thereof, the user graphic interface means including: any one or more of a name field for inputting a recipient's name according to a transaction type and transaction function; a phone number field for inputting a phone number; a cryptocurrency selection field for selecting a type of cryptocurrency (i.e., coin); a remittance amount input field for inputting a remittance amount (i.e., cryptocurrency amount) to be remitted; a remittance fee display field for displaying a remittance fee for the remittance amount; a remittance password input field; an escrow remittance request button for requesting escrow remittance, etc.

When requesting the escrow remittance after inputting and selecting corresponding information such as recipient information and remittance amount is input through the corresponding input fields, the remittance information including information input through the input fields and remittance information of the remitter is transmitted to the escrow non-face-to-face cryptocurrency transaction device 300.

At this time, the escrow non-face-to-face cryptocurrency transaction device 300 generates an escrow virtual wallet having a one-time escrow virtual wallet address for the remittance information, and then remits the cryptocurrency corresponding to the remittance amount, desired by the remitter to remit, from the remitter's phone number wallet to the escrow virtual wallet address and deposits the cryptocurrency.

After depositing the cryptocurrency to be remitted, the escrow non-face-to-face cryptocurrency transaction device 300 will provide a secure access path and a withdrawal authentication number to the remitter terminal 100-1. The secure access path may be a URL. As a method of providing the escrow authentication information including the secure access path and the withdrawal authentication number to the remitter terminal 100-1, there may be a direct provision method through the application program and an external service use method. The external service use method may include: any one or more of a mobile communication message service such as an e-mail and short message service (SMS); a messenger such as KakaoTalk and NateOn; a social network service such as Facebook; a push text of an external application program, etc. In the case of the external service use method, the escrow non-face-to-face cryptocurrency transaction device 300 should have account information such as an ID, an email address, and an alternative authentication identification information for the corresponding external service.

The remitter should provide the recipient with the escrow authentication information including the secure access path and the withdrawal authentication number, which are received from the escrow non-face-to-face cryptocurrency transaction device 300. The above-described direct provision method, the external service use method, the verbal communication method, etc. may be applied as the method for providing the escrow authentication information to the recipient.

The recipient who has obtained the secure access path and the withdrawal authentication number accesses the secure access path as shown in FIG. 2 through his or her recipient terminal or a terminal of another person not registered in the services, and for example, the recipient may confirm the deposit for 100 EVP of the cryptocurrency.

In addition, as shown in FIG. 3, the recipient may perform escrow deposit verification by inputting the secure access path and withdrawal authentication number through his or her recipient terminal 100-2, and at this time, after performing the escrow authentication by using the withdrawal authentication number, the escrow non-face-to-face cryptocurrency transaction device 300 will remit the cryptocurrency deposited in the escrow virtual wallet address to either a phone number wallet address or an external electronic wallet address, which are electronic wallet addresses, when escrow authentication is successful.

In addition, as shown in FIG. 4, the recipient may securely access the escrow virtual wallet address by clicking the secure access path received by the recipient terminal 100-2. At this time, the escrow non-face-to-face cryptocurrency transaction device 300 performs a withdrawal process by remitting the cryptocurrency deposited in the escrow virtual wallet address to a preset or input electronic wallet address when the input withdrawal authentication number is successfully authenticated.

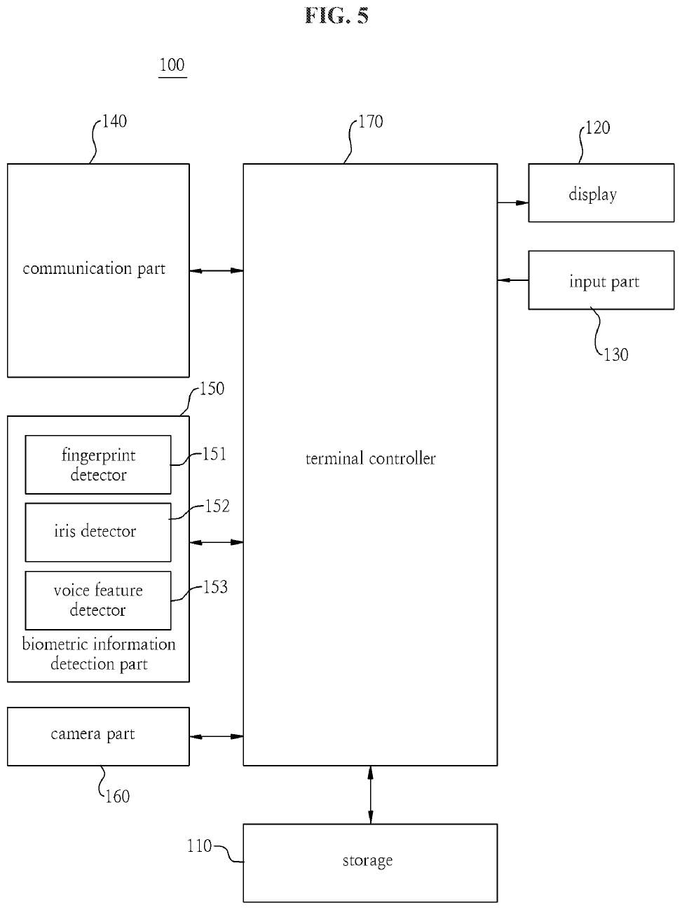

FIG. 5 is a view showing a configuration of a user terminal of the escrow non-face-to-face cryptocurrency transaction system using a phone number according to the present invention.

Referring to FIG. 5, the user terminal 100 includes: a storage 110, a display 120, an input part 130, a communication part 140, a biometric information detection part 150, a camera part 160, and a terminal controller 170.

The storage 110 includes: a general web application for accessing a web site provided by the escrow non-face-to-face cryptocurrency transaction device 300 for providing the escrow remittance service according to the present invention; and a dedicated application program (Hereinafter referred to as “app”) that directly communicates with the escrow non-face-to-face cryptocurrency transaction device 300, and includes: a program area storing a control program for controlling operation of the user terminal 100; a temporary area temporarily storing data generated while executing the control program; and a data area semi-permanently storing data generated while executing the control program and data necessary for execution of the control program.

The display 120 displays various information by means of at least one or more of texts, graphics, still images, and moving pictures.

The input part 130 includes: at least any one or more of a button input device provided with a plurality of buttons for controlling operations and functions of the user terminal 100 and outputting a button signal for a pressed button to a terminal controller; a key input device such as a keyboard provided with a plurality of keys capable of inputting characters and selecting various functions; a mouse; a touch pad integrally formed on a screen of the display 120 and outputting a position signal for a touched position to the terminal controller 170; and the like.

The communication part 140 connects to the wired and wireless data communication network 10 by way of either the wireless or wired network, and performs data communication with other devices, servers, and systems, which are connected to the wired and wireless data communication network 10.

The biometric information detection part 150 detects user's biometric information of the user terminal 100 and outputs the biometric information to the terminal controller 170.

The biometric information detection part 150 includes at least any one or more of a fingerprint detection part 151 that detects a fingerprint from a user's finger and outputs fingerprint information; an iris detection part 152 that detects an iris in a user's eye and outputs iris information; and a voice characteristic detection part 153 that detects voice characteristics from a user's voice and outputs voice characteristic information. The biometric information detection part 150 may further include: a face recognition detection part (not shown) that detects characteristics from a photographed facial image and outputs facial characteristic information; a behavior recognition detection part (not shown) that detects behavioral characteristics according to user's behavior (e.g., gait, signature, input pattern, gesture, etc.) and outputs behavioral characteristic information; and the like.

The camera part 160 outputs image data, generated by capturing an image entering a camera lens, to the terminal controller 170.

The terminal controller 170 controls the overall operation of the user terminal 100 according to the present invention, and through the input part 130, the biometric information detection part 150, the camera part 160, etc., obtains login account information, terminal identification information, identity authentication information, recipient information, a remittance password, remittance information, etc., which are required according to the present invention. The terminal controller 170 provides the information to the escrow non-face-to-face cryptocurrency transaction device 300 through the communication part 140 and displays the information received from the escrow non-face-to-face cryptocurrency transaction device 300 on the display 120.

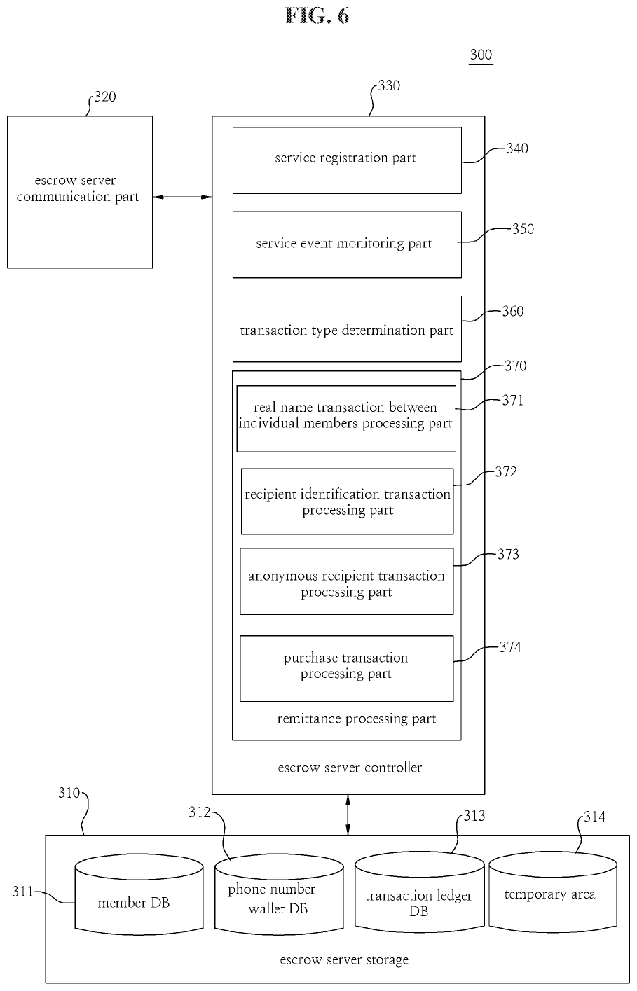

FIG. 6 is a view showing a configuration of an escrow non-face-to-face cryptocurrency transaction device of the escrow non-face-to-face cryptocurrency transaction system using a phone number according to the present invention.

Referring to FIG. 6, the escrow non-face-to-face cryptocurrency transaction device 300 includes an escrow server storage 310, an escrow server communication part 320, and an escrow server controller 330.

The escrow server storage 310 includes a member database (i.e., member DB) 311, a phone number wallet DB 312, a transaction ledger DB 313, and a temporary area 314.

The member DB 311 stores member information on users who have subscribed to the escrow remittance service. The member information includes: user personal information including a user's name, etc.; personal alternative identification information including an email, a phone number, etc.; identity authentication information; terminal identification information; a phone number wallet address; a remittance password, etc.

The phone number wallet DB 312 stores a phone number wallet for a phone number wallet address. The phone number wallet stores an original electronic wallet having an original electronic wallet address for at least one or more of cryptocurrency types held by a user, and each original electronic wallet may store any one or more of a public key which is the original electronic wallet address, a private key, and a transaction ledger block of cryptocurrency.

The transaction ledger DB 313 stores a transaction ledger including remittance details and reception details for each user according to the escrow remittance service, and stores a transaction ledger log of the escrow virtual wallet address. The transaction ledger log of the escrow virtual wallet address may include: remitter information; recipient information; a remittance cryptocurrency deposit date; a deposit remittance cryptocurrency withdrawal date; a remittance cryptocurrency deposit cancellation date; remittance cryptocurrency deposit waiting status; one-time escrow information generated for escrow remittance service, that is, information on a one-time escrow virtual wallet address and virtual wallet; escrow authentication information including a one-time secure access path and a withdrawal authentication number; recipient escrow authentication status, etc.

The temporary area 314 temporarily stores: an escrow virtual wallet address; an escrow virtual wallet for the escrow virtual wallet address; and a secure access path and a withdrawal authentication number for the escrow virtual wallet, according to the present invention.

The escrow server communication part 320 accesses the wired and wireless data communication network 10 to perform data communication with other terminals, devices, servers, systems, etc., which are connected to the wired and wireless data communication network 10.

The escrow server controller 330 includes a service registration part 340, a service event monitoring part 350, a transaction type determination part 360, and a remittance processing part 370, so as to control the overall operation of the escrow non-face-to-face cryptocurrency transaction device 300 according to the present invention.

The service registration part 340 obtains terminal identification information including personal information and phone number of a corresponding user from the user terminal 100 of the user who desires to subscribe to the cryptocurrency escrow remittance service, stores member information, including the personal information and terminal identification information, in the member DB 311 corresponding to the phone number, generates a phone number wallet having an electronic wallet address issued to the phone number, obtains an original electronic wallet address for each coin type and a private key which are selected by the user for the phone number wallet, stores the original electronic wallet address for each coin type and the private key in the phone number wallet DB 312 by mapping with the phone number wallet address and remittance password, and then registers the user as a member of the above cryptocurrency escrow remittance service.

The service event monitoring part 350 monitors whether a cryptocurrency escrow remittance service event occurs. The cryptocurrency escrow remittance service event may be generated by any one of a remitter's cryptocurrency remittance request, a purchaser's product purchase request, etc.

The transaction type determination part 360 analyzes remitter information and recipient information, which are included in the remittance information according to the generation of the cryptocurrency escrow remittance service event, determines whether the recipient is a member or not, and determines the transaction type according to a service type between the remitter and recipient.

The transaction type may be classified into four types: a real name transaction between members; a recipient identification transaction; an anonymous recipient transaction; and a product purchase transaction.

The remittance processing part 370 includes: a real name transaction processing part 371 between individual members; a recipient identification transaction processing part 372; an anonymous recipient transaction processing part 373; and a purchase transaction processing part 374.

The remittance processing part 370 receives the remittance information, including a phone number of a remitter and recipient information of a recipient, from a remitter terminal 100-1 according to the determined transaction type according to the first exemplary embodiment, generates an escrow virtual wallet having an escrow virtual wallet address applied with the personal information of the recipient, performs a remittance deposit process in which the cryptocurrency corresponding to a cryptocurrency remittance amount of the remittance information is remitted from a phone number wallet corresponding to the phone number and deposited in the escrow virtual wallet, provides a secure access path and a withdrawal authentication number to the remitter terminal 100-1, compares the withdrawal authentication number previously set for the escrow virtual wallet corresponding to the secure access path with the withdrawal authentication number received from the recipient terminal when the secure access path, the withdrawal authentication number, and the recipient's electronic wallet address are input from a recipient terminal 100-2 to receive the cryptocurrency, performs decryption authentication, and then performs the withdrawal process of remitting the cryptocurrency amount deposited in the escrow virtual wallet to the recipient's electronic wallet address upon successful authentication. The above description describes a case of recipient authentication, wherein the electronic wallet address is input from the recipient terminal 100-2, but in a case of the recipient non-authentication, the remittance processing part 370 may also obtain the electronic wallet address from the escrow server storage 310 upon login.

In a second exemplary embodiment, the remittance processing part 370 may be configured to deposit cryptocurrency, corresponding to the remittance amount of the cryptocurrency of the remittance information, into the escrow virtual wallet having the escrow virtual wallet address from the phone number wallet corresponding to the phone number wallet address when receiving the remittance information, perform the remittance deposit process in which the secure access path and withdrawal authentication number are generated to be provided to the remitter terminal 100-1, access the escrow virtual wallet of the escrow virtual wallet address when the secure access path is input from the recipient terminal 100-2, perform the escrow authentication by using the withdrawal authentication number, and then perform the withdrawal process in which the cryptocurrency amount deposited in the virtual wallet is remitted to the recipient's electronic wallet address upon successful authentication.

Specifically, when the transaction type is the real name transaction between individual members, by way of applying a real name recipient code included in the recipient information of the remittance information received through the remittance deposit process of any one of the first and second exemplary embodiments, the real name transaction processing part 371 generates an escrow virtual wallet having an escrow virtual wallet address, a secure access path, and a withdrawal authentication number, logs in through the web application or application program, receives the secure access path and withdrawal authentication number from the user terminal to perform the escrow authentication, and then performs the withdrawal process for the cryptocurrency amount deposited in the escrow virtual wallet upon successful authentication.

When the transaction type is the recipient identification transaction that requests recipient identification during the real name transaction between individual members, after performing the remittance deposit process, the recipient identification transaction processing part 372 requests login to the application program according to the recipient identification request when the recipient terminal 100-2 accesses the escrow virtual wallet address during the withdrawal process, receives the secure access path and the withdrawal authentication number from the user terminal to perform the escrow authentication after the recipient logs in as a member through the recipient terminal, and then performs the withdrawal process of remitting the cryptocurrency amount deposited in the escrow virtual wallet to the recipient's electronic wallet address upon successful authentication.

The recipient identification transaction processing part 372 may be configured to extract terminal identification information when a recipient requests the login to the application program as the member, and compares the recipient's name, phone number, and terminal identification information with the name, phone number, and terminal identification information of member information for the recipient registered in advance, and then allows the access after identifying the recipient,

When the above transaction type is the anonymous recipient transaction, through the remittance deposit process of the first and second exemplary embodiments and by applying the anonymous recipient code included in the received remittance information, the anonymous recipient transaction processing part 373 generates an escrow virtual wallet having an escrow virtual wallet address, a secure access path, and a withdrawal authentication number, and then while performing the escrow authentication, additionally performs the withdrawal process characterized in that the recipient directly inputs the electronic wallet address to be withdrawn.

When the transaction type is the product purchase transaction between a seller and a buyer, by way of applying the real name seller code which is the real name recipient code included in the seller information which is the recipient information of the remittance information received by the remittance deposit process of any one of the first and second exemplary embodiments, the purchase transaction processing part 374 generates an escrow virtual wallet having an escrow virtual wallet address, a secure access path, and a withdrawal authentication number, writes a transaction detail confirmation form including the cryptocurrency deposited as a payment between the remitter buyer and the recipient seller, transaction party information, order information, delivery check, etc., temporarily stores the transaction detail confirmation form by using an escrow payment transaction number as an access code per case, respectively provides the escrow payment transaction number to the remitter's terminal and the recipient's terminal, confirms product delivery and product receipt according to the escrow payment transaction number, approves a payment when the buyer accesses by using the escrow payment transaction number after confirming the product receipt, and then performs the withdrawal process by transmitting the escrow authentication information to the seller.

The real name recipient code, anonymous recipient code, real name seller code, etc. may be codes for classifying the transaction type.

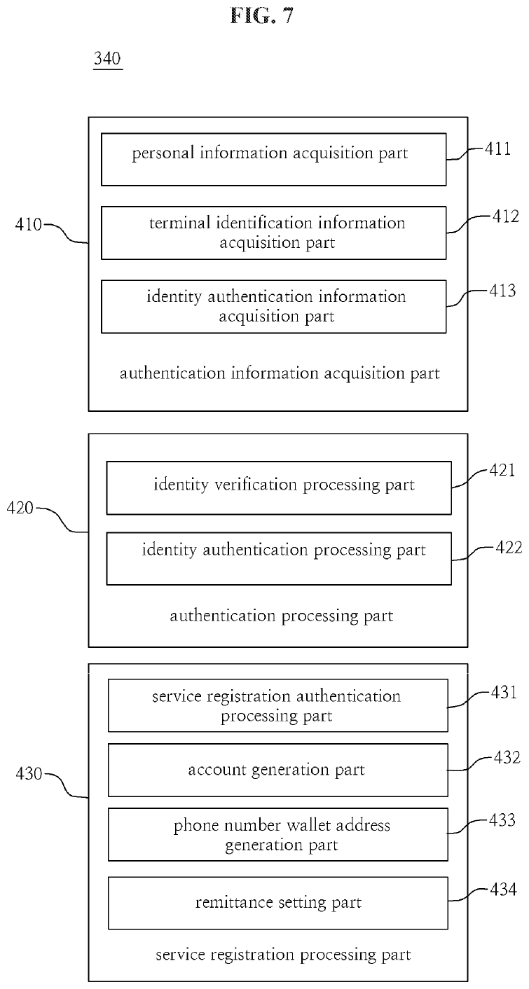

FIG. 7 is a view showing a configuration of a service registration part of an escrow server controller of the escrow non-face-to-face cryptocurrency transaction device in the escrow non-face-to-face cryptocurrency transaction system using a phone number according to the present invention.

The service registration part 340 of the escrow server controller 330 includes an authentication information acquisition part 410, an authentication processing part 420, and a service registration processing part 430.

The authentication information acquisition part 410 includes: a personal information acquisition part 411 that obtains personal information from the user terminal 100; a terminal identification information acquisition part 412 that obtains terminal identification information from the user terminal 100; and an identity authentication information acquisition part 413 that obtains identity authentication information through the user terminal 100. The personal information may be obtained through an identity verification message. In addition, the identity authentication information includes: biometric information such as fingerprint data, voice characteristic data, iris data, etc., and alternative authentication identification information such as a personal identification number (PIN) and a one-time QR code.

The authentication processing part 420 includes: an identity verification processing part 421 for obtaining an identity verification message including personal information and terminal identification information through the authentication information acquisition part 410, performing identity verification through the identity verification agency server 500, and performing the identity verification by checking whether a success result of the identity verification has been received accordingly; and an identity authentication processing part 422 for performing identity authentication based on identity authentication information obtained through the authentication information acquisition part 410.

The service registration processing part 430 includes: a service registration authentication processing part 431 for performing processes of identity verification and identity authentication through the authentication processing part 420 when a service subscription request occurs; an account generating part 432 for generating an account for a user who has requested the service subscription; a phone number wallet address generating part 433 for generating a phone number wallet address for the account and a phone number wallet for the phone number wallet address; and a remittance setting part 434 for issuing or inputting, and obtaining coin types to be used for remittance, and the original electronic wallet address and private key for each coin type, generating the phone number wallet for each original electronic wallet address, setting a remittance password capable of being used as a substitute by replacing the private key for the original electronic wallet address, and then obtaining and storing the remittance password from the user terminal 100.

The account generating part 432 generates an account by matching and registering a phone number ID, a terminal ID, and a plurality of identity authentication values, and the account may be set to be applicable to any one or more of the web application and application program.

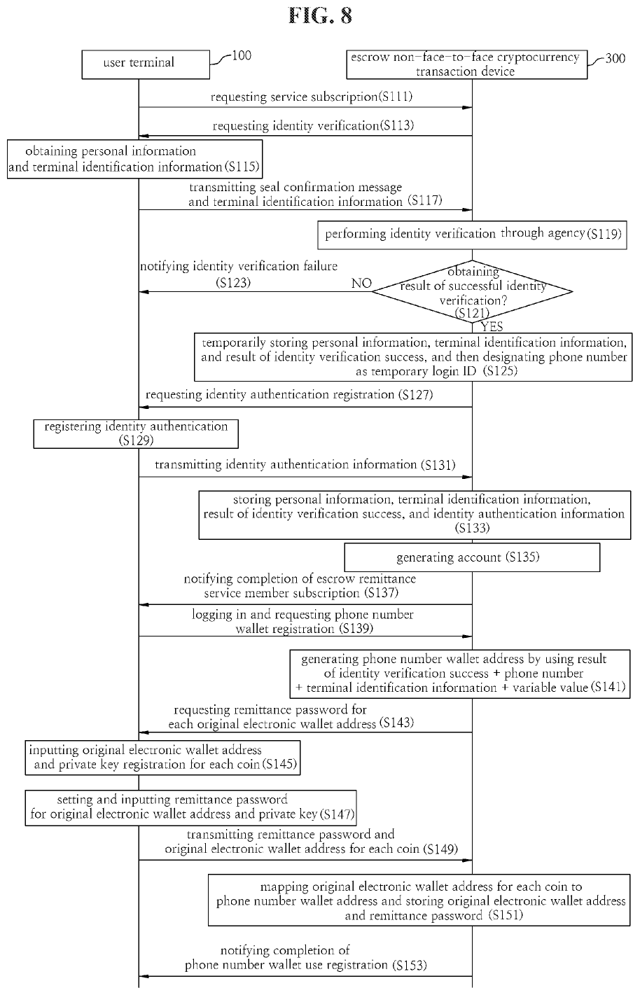

FIG. 8 is a flowchart showing a service member subscription method in the escrow non-face-to-face cryptocurrency transaction method using a phone number according to the present invention.

Referring to FIG. 8, in step S111, a service subscription request may be generated from the user terminal 100, and in step S113, when the service subscription request occurs, the escrow server controller 330 of the escrow non-face-to-face cryptocurrency transaction device 300 requests for checking of identification verification to the user terminal 100.

In step S115, the user terminal 100 requested for checking of the identification verification receives personal information and terminal identification information from a user or extracts and obtains the personal information and terminal identification information from the information previously stored in the storage 110, and then in step S117, transmits the terminal identification information and an identity verification message including the personal information to the escrow non-face-to-face cryptocurrency transaction device 300.

In step S119, when the identity verification message is received, the escrow server controller 330 performs the identity verification by providing the identity verification message to the identity verification agency server 500 of the identity verification agency.

In step S121, whether a result of identity verification succeeds, which is the result of identity verification received from an identity verification agency server 500, is checked.

In step S123, when a result of identity verification failure is received, an escrow server controller 330 notifies the identity verification failure to a user terminal 100. In step S125, when the result of identity verification success is received, personal information, terminal identification information, and the result of identity verification success are temporarily stored, and then a phone number is matched with a temporary login ID and saved to complete the identity verification.

In step S127, after completing the identity verification, the escrow server controller 330 requests the user terminal 100 to register the identity authentication information.

In step S129, the user terminal 100 receiving the request for registration of the identity authentication information obtains the identity authentication information, and then, in step S131, the user terminal 100 transmits the identity authentication information to the escrow non-face-to-face cryptocurrency transaction device 300.

In step S133, the escrow server controller 330 receiving the identity authentication information stores the personal information, the terminal identification information, the result of identity verification success, and the identity authentication information in an escrow server storage 310, and then, in step S135, the escrow server controller 330 matches and registers a phone number ID, the terminal identification information, and multiple identity authentication values, so as to complete account generation for at least one of an application program and web application.

In step S137, when the account generation is completed, the escrow server controller 330 notifies the user terminal 100 that membership subscription to the escrow remittance service has been completed.

In step S139, a user will log in to the escrow non-face-to-face cryptocurrency transaction device with a phone number as a temporary ID through the user terminal 100 and then request registration of a phone number wallet.

Then, in step S141, the escrow server controller 330 generates a phone number wallet address and the phone number wallet for the phone number wallet address by using the result of identity verification success, the phone number, the terminal identification information, and a variable value. The variable value may be any value.

In step S143, when the phone number wallet address and the phone number wallet are generated, the escrow server controller 330 transmits remittance password setting request information for each coin, requesting to set a remittance password for each original electronic wallet address, to the user terminal 100.

In step S145, when the request for setting the remittance password for each original electronic wallet address including a private key occurs, the user terminal 100 displays a remittance password user graphic interface means for each coin according to the request for setting the remittance password for each coin, and selects a coin to be used for remittance through the remittance password user graphic interface means for each coin, and in step S147, the user terminal 100 obtains the remittance password for each original electronic wallet address of the selected coin, and then in step S149, the user terminal 100 will transmit coin type information and the remittance password to the escrow non-face-to-face cryptocurrency transaction device 300.

In step 151, when the coin type information and the remittance password are received, the escrow server controller 330 of the escrow non-face-to-face cryptocurrency transaction device 300 generates an original electronic wallet address including a private key for each coin, and then stores the original electronic wallet address by mapping with the remittance password. In step S153, the escrow server controller 330 transmits completion notification information of phone number wallet use registration to the user terminal 100, informing that the phone number wallet use registration has been completed.

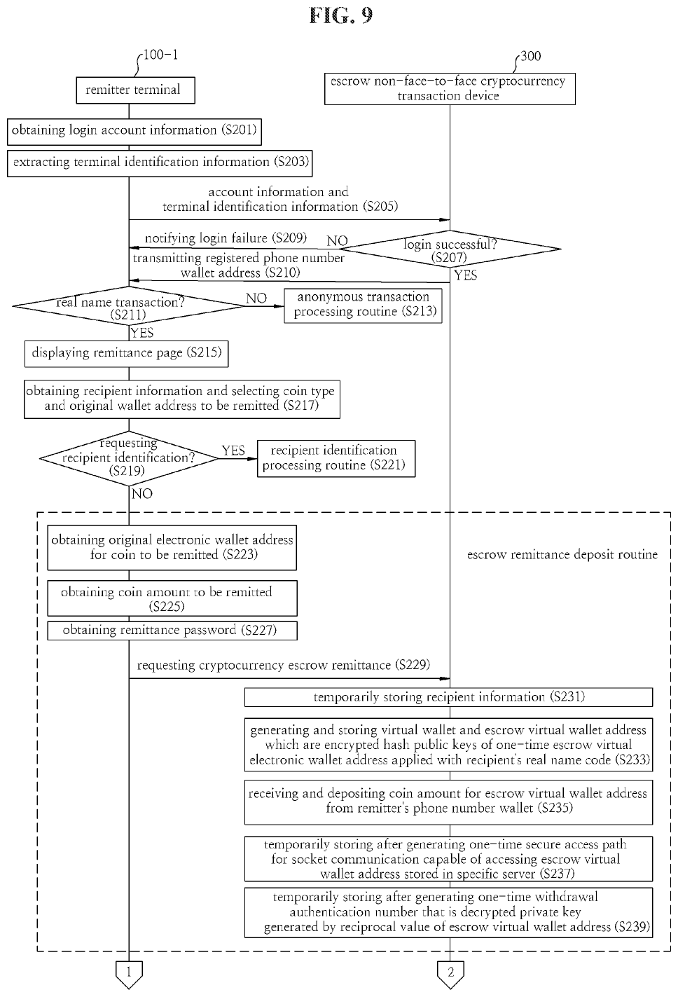

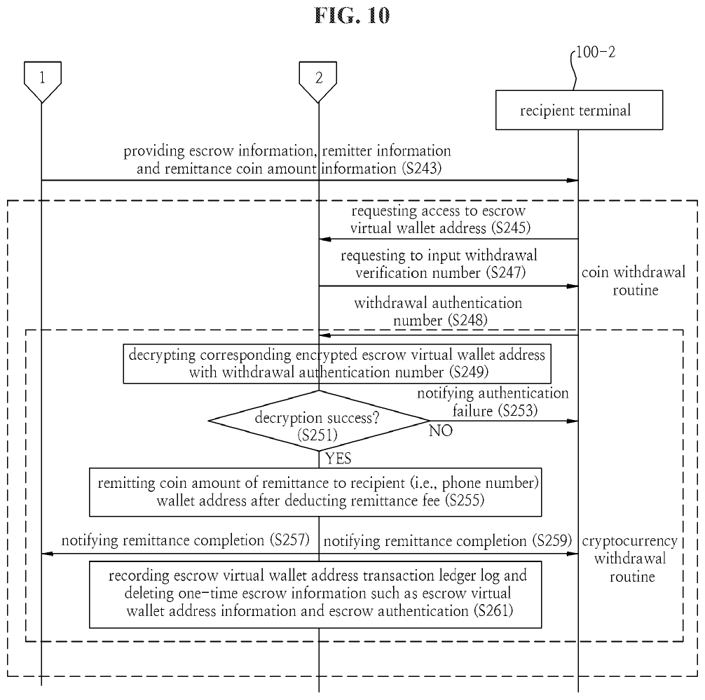

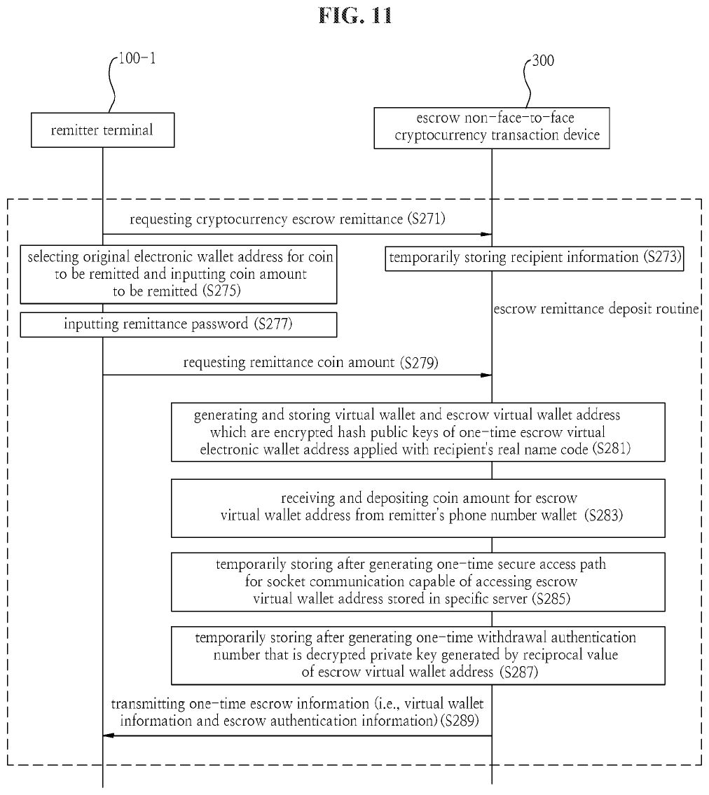

FIGS. 9 and 10 are flowcharts showing the escrow non-face-to-face cryptocurrency transaction method using a phone number, the flowcharts showing an escrow remittance method according to a first exemplary embodiment of the present invention. FIG. 11 is a flowchart showing an escrow remittance method according to a second embodiment of the escrow non-face-to-face cryptocurrency transaction method using a phone number of the present invention, the flowchart showing a real name transaction method between members.

Referring to FIGS. 9 to 11, in step S201, a remitter terminal 100-1 obtains login account information from a remitter, and in step S203, extracts terminal identification information, and then in step S205, transmits the login account information and terminal identification information to the escrows non-face-to-face cryptocurrency transaction device 300. It is preferable that the login account information includes a phone number ID, which is a phone number, and identity authentication information.

In step S207, the escrow non-face-to-face cryptocurrency transaction device 300 receiving the login account information and terminal identification information compares the received login account information and terminal identification information with the registered login account information and terminal identification information to determine whether the login is successful, and in step S209, when the login fails, the login failure is notified to the remitter terminal 100-1, and then in step S210, when login is successful, the phone number wallet address of the registered phone number system is transmitted to the remitter terminal 100-1.

In step S211, after receiving the phone number wallet address of the registered phone number system, the remitter terminal 100-1 will display the phone number wallet address on a display 120 and then determine whether a real name transaction has been made.

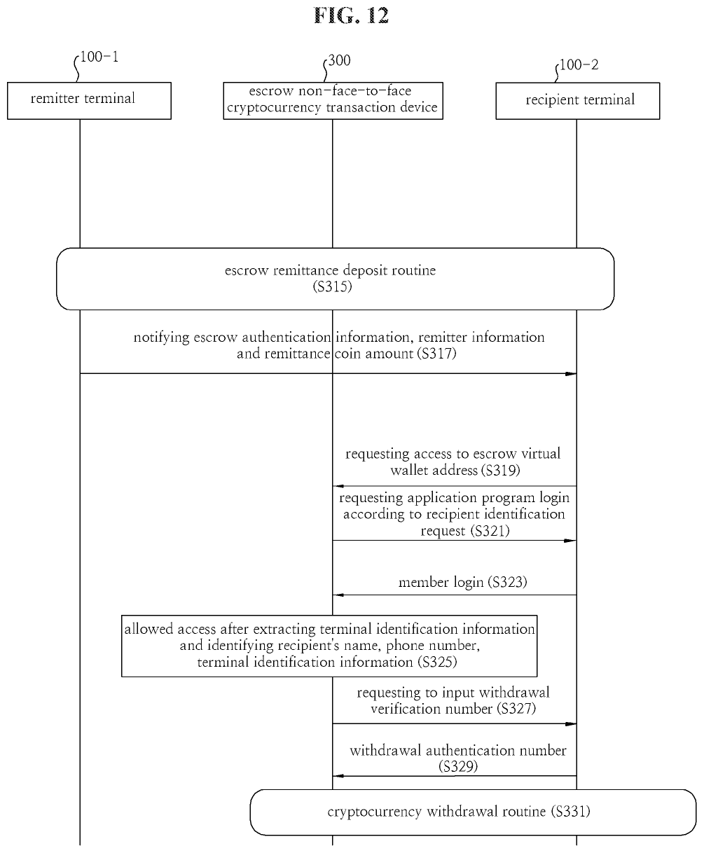

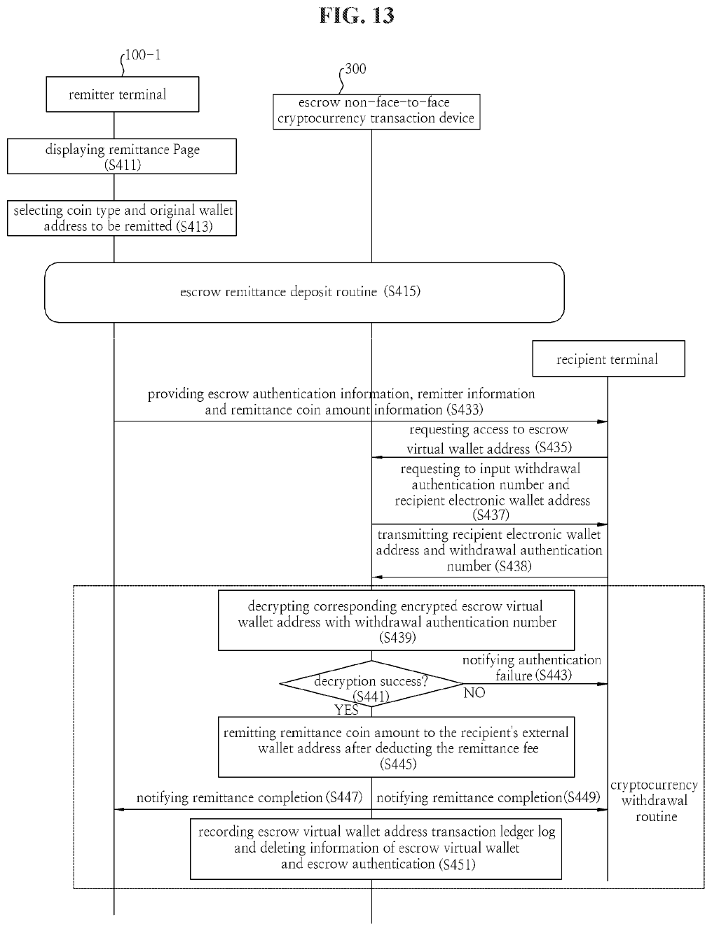

In step S213, when an anonymous transaction is performed other than the real name transaction, the remitter terminal 100-1 and the escrow non-face-to-face cryptocurrency transaction device 300 perform an anonymous transaction processing routine for performing remittance to an anonymous recipient. The anonymous transaction processing routine will be described in detail with reference to FIGS. 12 and 13 below.

In step S215, in the case of the real name transaction, the remitter terminal 100-1 displays the cryptocurrency remittance user graphic interface means on the display 120, and in step 217, recipient information is obtained from the remitter, and the coin type and original electronic wallet address to be remitted are selected. The cryptocurrency remittance user graphic interface means may be provided in the form of a web page or displayed in the form of an application page.

In step S219, when the recipient information, coin type, and original electronic wallet address are selected, the remitter terminal 100-1 determines whether a user requests recipient identification through the cryptocurrency remittance user graphic interface means, and in step S221, when the recipient identification is requested, the remitter terminal 100-1 performs a recipient identification processing routine to remit the cryptocurrency after performing the recipient identification and performing escrow authentication which authenticates a secure access path and a withdrawal authentication number. The recipient identification processing routine will be described in detail with reference to FIG. 11 below.

When only a real name transaction is requested, the remitter terminal 100-1 and the escrow non-face-to-face cryptocurrency transaction device 300 perform an escrow remittance deposit routine according to the first exemplary embodiment.

In steps S223 and S225, the remitter terminal 100-1 allows the user to select the original electronic wallet address and recipient information, which are selected for a coin to be remitted, and takes input from the user and obtains the amount of coin to be remitted (or “remittance amount”).

In step S227, when the original electronic wallet address and remittance amount are obtained, the remitter terminal 100-1 receives and obtains a remittance password from the input made by the user.

In step S229, when the original electronic wallet address, remittance amount, and remittance password are obtained, the remitter terminal 100-1 transmits coin amount remittance request information including the recipient information, the original electronic wallet address, the remittance amount, and the remittance password to the escrow non-face-to-face cryptocurrency transaction device 300 to request remittance.

In step S231, the escrow server controller 330 of the escrow non-face-to-face cryptocurrency transaction device 300 receiving the coin amount remittance request information temporarily stores the recipient information, and in step S233, generates a one-time escrow virtual wallet address applied with a real name recipient code, generates an escrow virtual wallet corresponding to the escrow virtual wallet address, and then stores the escrow virtual wallet address and escrow virtual wallet on a specific server among multiple servers.

In step S235, when the escrow virtual wallet is generated, the escrow server controller 330 receives the cryptocurrency of the remittance amount from the original electronic wallet address of a remitter's phone number wallet, remits the cryptocurrency to the escrow virtual wallet of the escrow virtual wallet address, and deposits the remittance amount in the escrow virtual wallet.

In step S237, the escrow server controller 330 generates and temporarily stores a secure access path for one-time socket communication capable of accessing the escrow virtual wallet stored in the specific server, and in step S239, generates and temporarily stores a one-time withdrawal authentication number, which is a decrypted private key generated by a reciprocal value of the escrow virtual wallet address.

In the description, it is described such that an escrow virtual wallet is generated and stored in a specific server, a secure access path and a withdrawal authentication number are generated, and cryptocurrency is remitted. However, it is also possible to configure the process such that cryptocurrency of remittance amount is remitted from an original electronic wallet address of a remitter's phone number wallet immediately after a one-time escrow virtual wallet is generated, and a secure access path and a withdrawal authentication number are generated before the cryptocurrency is remitted and deposited to the escrow virtual wallet of the virtual wallet address.

In addition, as shown in FIG. 11, the escrow server controller 330 of the escrow non-face-to-face cryptocurrency transaction device 300 may be configured such that an escrow virtual wallet address, an escrow virtual wallet, a secure access path, and a withdrawal authentication number are firstly generated to provide escrow authentication information to the remitter terminal 100-1 before escrow remittance information is received, cryptocurrency corresponding to the remittance amount is remitted by applying a remittance password at an original electronic wallet address of the escrow remittance information, and the cryptocurrency is deposited in the escrow virtual wallet of the escrow virtual wallet address by remittance to a one-time escrow virtual wallet address.

Specifically, in step S271, the remitter terminal 100-1 transmits cryptocurrency escrow remittance request information, for requesting real name cryptocurrency remittance between members, to the escrow non-face-to-face cryptocurrency transaction device 300.

In step S273, the escrow server controller 330 of the escrow non-face-to-face cryptocurrency transaction device 300 temporarily stores recipient information included in the received cryptocurrency escrow remittance request information.

In step S275, the remitter terminal 100-1 receiving the escrow authentication information, allows a user to select an original electronic wallet address and recipient information for a coin to be remitted, and takes input from the user and obtains the amount of coin to be remitted (or “remittance amount”).

In step S277, when the original electronic wallet address and remittance amount are obtained, the remitter terminal 100-1 receives and obtains a remittance password from input made by the user.

In step S279, when the original electronic wallet address, remittance amount, and remittance password are obtained, the remitter terminal 100-1 transmits the coin amount remittance request information including the original electronic wallet address, remittance amount, and remittance password to the escrow non-face-to-face cryptocurrency transaction device 300 to request remittance.

In step S281, the escrow non-face-to-face cryptocurrency transaction device 300 receiving the coin amount remittance request information generates and stores an escrow virtual wallet address, which is an encrypted hash public key of the one-time escrow virtual electronic wallet address applied with the real name recipient code. When the escrow non-face-to-face cryptocurrency transaction device 300 is configured with a plurality of servers, the generated escrow virtual wallet address may be provided to a plurality of specific servers that manage only the phone number wallets, and may be stored in any of the specific servers.

In step S283, the escrow server controller 330 of the escrow non-face-to-face cryptocurrency transaction device 300 receives cryptocurrency of remittance amount remitted from the original electronic wallet of the original electronic wallet address of the remitter's phone number wallet to the escrow virtual wallet of the escrow virtual wallet address, so as to deposit the remittance amount in the escrow virtual wallet.

In step S285, the escrow server controller 330 generates and temporarily stores a secure access path for one-time socket communication capable of accessing the one-time escrow virtual wallet address stored in the specific server, and in step S287, generates and temporarily stores a one-time withdrawal authentication number, which is a decrypted private key generated by a reciprocal value of the escrow virtual wallet address.

In step S289, when the secure access path and withdrawal authentication number are generated, the escrow server controller 330 transmits the escrow authentication information including the secure access path and the withdrawal authentication number to the remitter terminal 100-1.

When the escrow remittance deposit routine of the first or second exemplary embodiment as described above is completed, the remitter should provide escrow authentication information, remitter information, and remittance coin amount information to the recipient.

The method of providing the escrow authentication information, remitter information, and the remittance coin amount information may be applied with a method of a verbal communication method in which a remitter speaks directly to a recipient, an online delivery method provided directly to a recipient terminal 100-2 through a remitter terminal 100-1 which is a user terminal 100, etc. As the online delivery method, there may be a delivery means including: a messenger such as Nate-On and KakaoTalk, a social network service such as Facebook and KakaoStory, a mobile communication message such as e-mail and short message service (SMS), etc.

When the escrow authentication information is notified to the recipient, and the remitter information and remittance coin amount information are transmitted to the recipient terminal 100-2, the recipient terminal 100-2 and the escrow non-face-to-face cryptocurrency transaction device 300 perform a cryptocurrency withdrawal routine.

Specifically explaining the cryptocurrency withdrawal routine, in step S245, the recipient terminal 100-2 transmits escrow virtual wallet address access request information including the secure access path of the escrow authentication information to the escrow non-face-to-face cryptocurrency transaction device 300, so as to request access to the escrow virtual wallet address. The escrow virtual wallet address access request information may be displayed when confirming deposit as in FIG. 2, or when confirming remittance and deposit as in FIG. 3, or when requesting withdrawal as in FIG. 4.

In step S247, the escrow server controller 330 of the escrow non-face-to-face cryptocurrency transaction device 300 provides a cryptocurrency type and a remittance amount deposited in the escrow virtual wallet of the escrow virtual wallet address of the corresponding secure access path when the escrow virtual wallet address access request information is received from the recipient terminal 100-2, and transmits withdrawal authentication number input request information to the recipient terminal 100-2 when the recipient terminal 100-2 is related based on any one of the deposit confirmation of FIG. 3 and the withdrawal request of FIG. 4.

In step S248, when a withdrawal authentication number input request information is received, the recipient terminal 100-2 obtains the withdrawal authentication number from the user and transmits the withdrawal authentication number to the escrow non-face-to-face cryptocurrency transaction device 300.

When the withdrawal authentication number is obtained, the escrow server controller 330 performs the cryptocurrency withdrawal routine.

Specifically describing the cryptocurrency withdrawal routine, in step S249, when a withdrawal authentication number is obtained from the recipient terminal 100-2 after requesting input of the withdrawal authentication number, the escrow server controller 330 compares the withdrawal authentication number with a preset withdrawal authentication number and performs a decryption process in which the corresponding encrypted escrow virtual wallet address is decrypted with the withdrawal authentication number, and then in step S253, the escrow server controller 330 determines whether the decryption is successful.

In step S253, when the decryption fails, the authentication failure for the withdrawal authentication number is transmitted to the recipient terminal 100-2, and in step S255, among the remittance amount and the remittance fees, which are deposited after receiving from the remitter, the remittance fee is deducted from the escrow virtual wallet address, and then the cryptocurrency is withdrawn, when the decryption is successful.

In steps of S257 and S259, after withdrawing the cryptocurrency, the escrow server controller 330 respectively transmits remittance completion notification information to the remitter terminal 100-1 and the recipient terminal 100-2, notifying that the withdrawal has been completed. In step S261, after recording an escrow virtual wallet address ledger log, the escrow server controller 330 deletes the escrow authentication information that includes the one-time escrow virtual wallet address, the one-time escrow virtual wallet information, the one-time secure access path, and the withdrawal authentication number.

FIG. 12 is a flowchart showing the escrow non-face-to-face cryptocurrency transaction method using a phone number according to the second exemplary embodiment of the present invention.

Referring to FIG. 12, a recipient identification request is generated as in FIG. 9 described above.

At this time, in step S315, the escrow server controller 330 similarly performs the escrow remittance deposit routine described in FIG. 9, and then in step S317, notifies the escrow authentication information, the remitter information, and the remittance amount to the recipient terminal 100-2. However, a recipient identification information request flag indicating that recipient identification information is required may be set in an escrow virtual wallet address and an escrow virtual wallet, which are provided with the escrow virtual wallet address generated in the escrow remittance deposit routine.

In step S319, after obtaining the escrow authentication information, the remitter information, and the remittance amount, the recipient terminal 100-2 transmits escrow virtual address access request information for requesting access to the escrow virtual wallet address according to the secure access path information in the escrow authentication information to the escrow non-face-to-face cryptocurrency transaction device 300.

In step S321, the escrow server controller 330 receiving the escrow virtual wallet address access request information accesses the escrow virtual wallet for the secure access path of the escrow virtual wallet address access request information, and when it is confirmed that the recipient identification information request flag mapped to the corresponding escrow virtual wallet address is set, the escrow server controller 330 transmits application program login request information for requesting the application program login according to the recipient identification request to the recipient terminal 100-2.

In step S323, the recipient terminal 100-2 receiving the application program login request information calls the corresponding application program by a user or by a connection signal at a time of connection and executes the app, and then transmits member login information to the escrow non-face-to-face cryptocurrency transaction device 300.

In step S325, the escrow server controller 330 of the escrow non-face-to-face cryptocurrency transaction device 300 receiving the member login information extracts the terminal identification information of the recipient terminal 100-2, obtains the name and phone number of the recipient according to the member login information, identifies the recipient's name, phone number, and terminal identification information, and then allows access to the escrow virtual wallet with the escrow virtual wallet address.

In step S327, when the access is allowed, the escrow server controller 330 requests to input a withdrawal authentication number for decrypting the encrypted one-time escrow virtual wallet address in the escrow virtual wallet, and in step S329, the withdrawal authentication number is input accordingly, and then in step S331, the cryptocurrency withdrawal routine described in FIG. 10 is performed.

FIG. 13 is a flowchart showing the escrow non-face-to-face cryptocurrency transaction method using a phone number according to a third exemplary embodiment of the present invention, and is the flowchart for anonymously remitting cryptocurrency when a recipient is a non-member.

Referring to FIG. 13, in step S411, when an anonymous transaction is selected other than a real name transaction as in FIG. 9, the remitter terminal 100-1 displays the remittance password user graphic interface means for each original electronic wallet address including the private key, and in step S413, receives a selection of the coin type and the original electronic wallet address to be remitted from the user through the remittance password user graphic interface means for each coin without selecting or inputting the recipient information, unlike the real name transaction, and then in step S415, performs the escrow remittance deposit routine of the first or second exemplary embodiment described above.

In step S433, the remitter terminal 100-1 provides the escrow authentication information, remitter information, and remittance coin amount information to the recipient terminal 100-2 after performing the escrow remittance deposit routine.

In step S435, when the escrow authentication information, remitter information, and remittance coin amount information are provided to the recipient terminal 100-2, the recipient terminal 100-2 transmits the escrow virtual wallet address access request information including the secure access path to the escrow non-face-to-face cryptocurrency transaction device 300.

In step S437, when the escrow virtual wallet address access request information is received, the escrow server controller 330 requests input of the withdrawal authentication number and the recipient electronic wallet address. The recipient's electronic wallet address may be a phone number wallet address of the same phone number wallet, or a recipient's electronic wallet address managed by an external cryptocurrency exchange server 200.

In step S438, the recipient terminal 100-2 receives the electronic wallet address and withdrawal authentication number from the recipient and transmits the electronic wallet address and withdrawal authentication number to the escrow non-face-to-face cryptocurrency transaction device 300.

The escrow server controller 330, which has received the recipient electronic wallet address and withdrawal authentication number from the recipient terminal 100-2, will perform the above-described cryptocurrency withdrawal routine in the same manner. However, the cryptocurrency of the remittance amount will be remitted to the phone number wallet address or the external electronic wallet address managed by the external cryptocurrency exchange server 200.

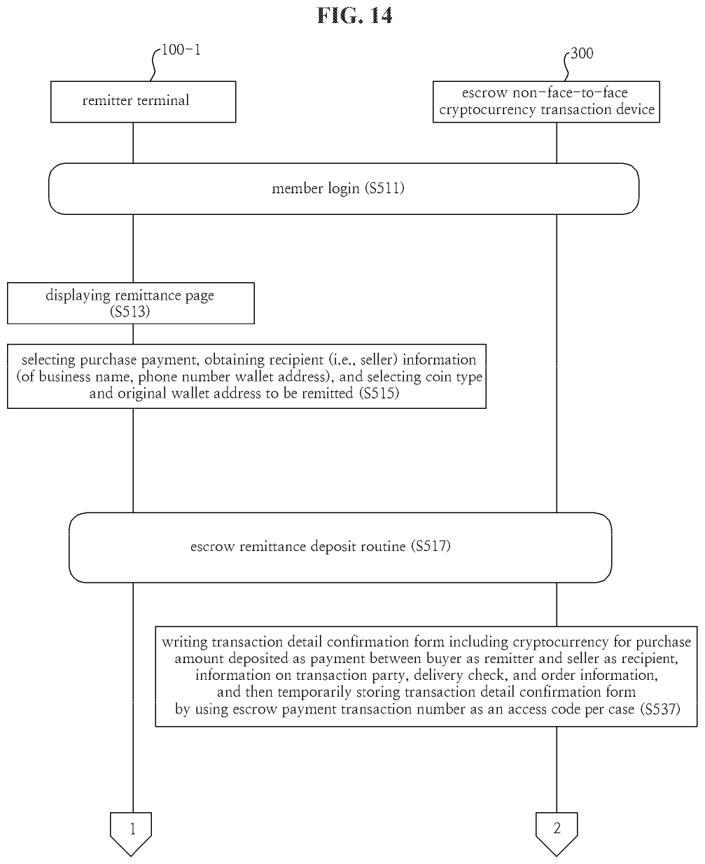

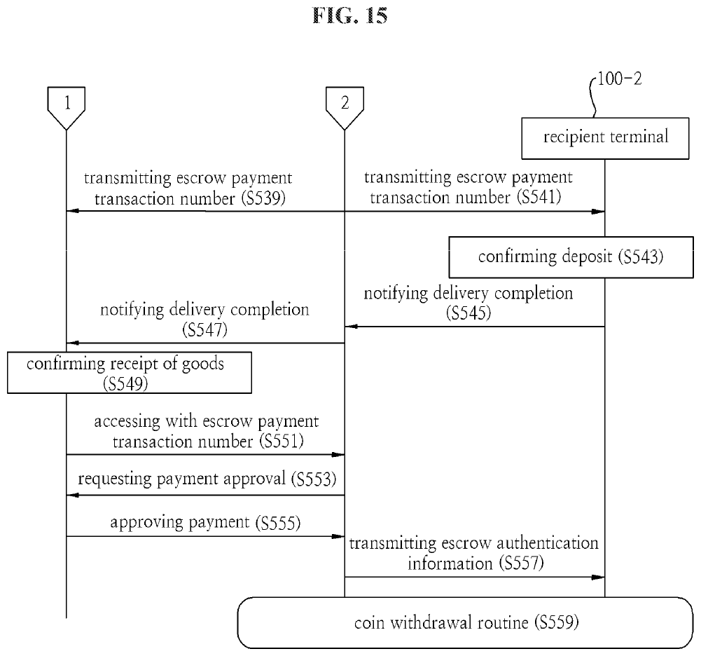

FIGS. 14 and 15 are flowcharts showing the escrow non-face-to-face cryptocurrency transaction method using a phone number according to a fourth exemplary embodiment, and showing a cryptocurrency transaction method between a buyer and a seller.

Referring to FIGS. 14 and 15, here, the remitter is the buyer, the recipient is the seller, the remitter terminal 100-1 is a buyer terminal, and the recipient terminal 100-2 is a seller terminal.

In step S511, the remitter terminal 100-1 should log in to the escrow non-face-to-face cryptocurrency transaction device 300 as a member.

In step S513, the remitter terminal 100-1 displays the remittance password user graphic interface means for each coin when logging in to the escrow non-face-to-face cryptocurrency transaction device 300. In step S515, through the remittance password user graphic interface means for each coin, the remitter terminal 100-1 selects a purchase payment and obtains recipient information, selects the coin type to be remitted, and obtains the original electronic wallet address for the selected coin.

The remitter terminal 100-1 and the escrow non-face-to-face cryptocurrency transaction device 300 perform the escrow remittance deposit routine of the first or second exemplary embodiment described above.

In step S537, when the cryptocurrency corresponding to the payment amount is deposited, the escrow server controller 330 writes a transaction detail confirmation form including the cryptocurrency deposited as a payment settlement between the remitter buyer and the recipient seller, transaction party information, order information, delivery check, etc., and then the escrow server controller 330 generates an escrow payment transaction number, and temporarily stores the transaction detail confirmation form by using the escrow payment transaction number as an access code per case.

In steps of S539 and S541, after converting the access code of the transaction detail confirmation form, the escrow server controller 330 respectively transmits the escrow payment transaction numbers to the remitter terminal 100-1 and the recipient terminal 100-2.

In step S543, after logging in to the escrow non-face-to-face cryptocurrency transaction device 300, the recipient terminal 100-2 confirms the deposit by using the escrow payment transaction number applied by the recipient seller, and in step S545, upon the confirmation, transmits the delivery completion notification information to the escrow non-face-to-face cryptocurrency transaction device 300.

Then, in step S547, the escrow server controller 330 transmits the delivery completion notification information to the remitter terminal 100-1 of the buyer through the transaction details confirmation form.

In step S551, after receiving the product, when the buyer confirms receipt of the product in the transaction detail confirmation form through the remitter terminal 100-1 logged in to the escrow non-face-to-face cryptocurrency transaction device 300, the escrow payment transaction number is used to connect to the escrow non-face-to-face cryptocurrency transaction device 300.

Then, in step S553, the escrow server controller 330 transmits the payment approval request information to the remitter terminal 100-1, and in step S557, when payment approval information is received with respect to the transmitted payment approval request information, the one-time escrow authentication information is transmitted to the recipient terminal 100-2, and finally in step S559, the above-described coin withdrawal routine is performed.

Meanwhile, the present invention is not limited to the above-described typical preferred exemplary embodiments, but it will be readily understood by those skilled in the art that various improvements, changes, replacements, or additions can be performed within the scope not departing from the gist of the present invention. When embodiments by such improvements, changes, replacements, or additions falls within the scope of the following appended claims, the technical idea should also be regarded as belonging to the present invention.

### DESCRIPTION OF THE REFERENCE NUMERALS IN THE DRAWINGS

10: wired/wireless data communication network
100: user terminal
110: storage
120: display
130: input part
140: communication part
150: biometric information detection part
160: camera part
200: external cryptocurrency exchange
300: escrow non-face-to-face cryptocurrency transaction device
310: escrow server storage
311: member DB
312: phone number wallet DB
313: transaction ledger DB
314: temporary area
320: escrow server communication part
330: escrow server controller
340: service registration part
350: service event monitoring part
360: transaction type determination part
370: remittance processing part
500: identity verification agency server

What is claimed is:

1. An escrow non-face-to-face cryptocurrency transaction device using a phone number, the device comprising:
an escrow server communication part that connects to a wired/wireless data communication network and performs data communication with other devices connected to the wired/wireless data communication network;
an escrow server storage comprising:
a member DB that stores user's personal information including the phone number,
a phone number wallet DB that stores a phone number wallet having a phone number wallet address issued by mapping to the phone number and manages cryptocurrency of a user in the phone number wallet by storing the cryptocurrency in an original electronic wallet address for each type of a corresponding cryptocurrency, and
a temporary area that stores a one-time escrow virtual wallet having a one-time escrow virtual wallet address; and
an escrow server controller that receives remittance information including a remitter's phone number and recipient's recipient information of a recipient from a remitter terminal, generates the escrow virtual wallet having the one-time escrow virtual wallet address to which recipient's personal information is applied, deposits the cryptocurrency corresponding to a remittance amount of the cryptocurrency of the remittance information from the phone number wallet corresponding to the phone number to the escrow virtual wallet, generates escrow authentication information including a one-time secure access path and a withdrawal authentication number, provides the secure access path and the withdrawal authentication number to the remitter terminal, compares a withdrawal authentication number received from a recipient terminal with a withdrawal authentication number previously set for the escrow virtual wallet corresponding to the secure access path when the secure access path, the withdrawal authentication number, and a recipient's electronic wallet address are input from the recipient terminal to receive the cryptocurrency, performs decrypted escrow authentication, and remits a cryptocurrency amount deposited in an escrow virtual wallet address to the recipient's electronic wallet address when the escrow authentication is successful.

2. The device of claim 1, wherein the escrow server controller comprises:
a service event monitoring part that monitors whether a cryptocurrency escrow remittance service event occurs;
a transaction type determination part that determines whether a recipient is a member according to an occurrence of the cryptocurrency escrow remittance service event, and a transaction type according to a service type between a remitter and the recipient; and
a remittance processing part that receives the remittance information including the remitter's phone number and the recipient's recipient information from the remitter terminal according to the determined transaction type, generates the escrow virtual wallet having the escrow virtual wallet address to which the recipient's personal information is applied, performs a remittance deposit process in which the cryptocurrency corresponding to the remittance amount of the cryptocurrency of the remittance information is deposited by remitting the cryptocurrency from the phone number wallet corresponding to the phone number to the escrow virtual wallet address after generation of the escrow virtual wallet, generates the secure access path and the withdrawal authentication number after the remittance deposit process, performs a remittance process providing the secure access path and withdrawal authentication number to the remitter terminal, performs decryption authentication after comparing the withdrawal authentication number previously set for the escrow virtual wallet corresponding to the secure access path with the withdrawal authentication number received from the recipient terminal when the secure access path, the withdrawal authentication number, and the recipient's electronic wallet address are input from the recipient terminal to receive the cryptocurrency, and performs a withdrawal process by remitting the cryptocurrency amount deposited in the escrow virtual wallet to the recipient's electronic wallet address upon successful authentication.

3. The device of claim 2, wherein the remittance processing part comprises:
a real name transaction processing part between individual members, the real name transaction processing part generating the escrow virtual wallet having the escrow virtual wallet address to which a real name recipient code included in the recipient information of received remittance information is applied, performing the remittance deposit process when the transaction type is a real name transaction between individual members after the escrow virtual wallet is generated, generating the secure access path and the withdrawal authentication number and transmitting the secure access path and the withdrawal authentication number to the remitter terminal after a deposit process is performed, and performing the remittance process and the withdrawal process;
a recipient identification transaction processing part performing the remittance deposit process and the remittance process when the transaction type is a recipient identification transaction among the real name transactions between individual members, requesting an application program login according to a recipient identification request when the recipient terminal accesses the escrow virtual wallet address during the withdrawal process, and then performing the escrow authentication by receiving the withdraw authentication number from a user terminal after recipient logs in as the member through the recipient terminal, and performing the withdrawal process of remitting the cryptocurrency amount deposited in the escrow virtual wallet address to the recipient's electronic wallet address when the escrow authentication is successful;
an anonymous recipient transaction processing part performing the remittance deposit process by generating the escrow virtual wallet having the escrow virtual wallet address to which an anonymous recipient code included in the received remittance information is applied when the transaction type is an anonymous recipient transaction, and then performing the remittance processing and withdrawal processing after generating the secure access path and the withdrawal authentication number; and
a purchase transaction processing part performing the remittance deposit process by generating the escrow virtual wallet with the escrow virtual wallet address applied with a real name seller code which is the real name recipient code included in seller information which is the recipient information of the received remittance information, when the transaction type is a product purchase transaction between a buyer and a seller, generating and temporarily storing the escrow authentication information including the secure access path and a payment verification number, writing a transaction detail confirmation form including the cryptocurrency amount deposited as a payment between the buyer as the remitter and the seller as the recipient, information on the transaction party, order information, and delivery check, temporarily storing the transaction detail confirmation form by using the escrow payment transaction number as an access code per case, respectively providing the escrow payment transaction numbers to the remitter's terminal and the recipient's terminal, confirming product delivery and product receipt according to the escrow payment transaction number, confirming receipt of product, approving payment upon access by the buyer by the escrow payment transaction number, performing the remittance process of transmitting the escrow authentication information only to the seller, and then performing the payment process.

4. The device of claim 3, wherein the recipient identification transaction processing part extracts terminal identification information when the recipient requests to log in to a member application program, and identifies the recipient by comparing name, phone number, and terminal identification information of the recipient with name, phone number, and terminal identification information of member information for the recipient who has previously registered, so as to allow an access.

5. The device of claim 1, wherein the escrow server controller further comprises a service registration part obtaining terminal identification information including personal information and a user's phone number from the user who desires to subscribe to a cryptocurrency escrow remittance service, storing member information including the personal information and the terminal identification information in response to the phone number, generating the phone number wallet having the electronic wallet address issued by the phone number, newly issuing the original electronic wallet address and a private key for each coin type selected by the user for the phone number wallet or obtaining the original electronic wallet address and the private key which are input from an external cryptocurrency exchange, storing the original electronic wallet address and the private key after mapping with the phone number wallet address and a remittance password, and then registering the user as a member of the cryptocurrency escrow remittance service.

6. The device of claim 5, wherein the service registration part comprises:
an authentication information acquisition part comprising a personal information acquisition part obtaining the personal information from a user terminal and a terminal identification information acquisition part for obtaining the terminal identification information including the phone number from the user terminal;
an authentication processing part performing identity verification by at least one of the personal information and the terminal identification information through an external identity verification agency and storing a result of successful identity verification received from the external identity verification agency upon successful verification; and
a service registration processing part storing the member information including the personal information and the terminal identification information in response to the phone number upon successful authentication through the authentication processing part, generating the phone number wallet having the phone number wallet address issued by the phone number, obtaining the original electronic wallet address for each coin type selected by the user for the phone number wallet by newly issuing or inputting the original electronic wallet address, storing the original electronic wallet address after mapping with the phone number wallet address and the remittance password, and then registering the user as the member of the escrow remittance service.

7. The device of claim 6, wherein the authentication information acquisition part further comprises an identity authentication information acquisition part obtaining and storing at least one of a user's personal identification number (PIN), biometric information, a one-time QR code, and alternative authentication identification information from the user terminal, wherein the escrow server controller receives identity authentication information by the user terminal when the remitter or recipient logs in as the member, performs identity authentication by comparing entered identity authentication information with stored identity authentication information, and allows the user to log in when the identity authentication is successful.

8. The device of claim 1, wherein the escrow server controller transmits the cryptocurrency of the remittance amount deposited in the escrow virtual wallet to the recipient's electronic wallet address, and then deletes the escrow authentication information including the one-time escrow virtual wallet address, escrow virtual wallet information, the one-time secure access path, and the withdrawal authentication number.

9. An escrow non-face-to-face cryptocurrency transaction method using a phone number, the method comprising:
a cryptocurrency amount remittance deposit process, wherein an escrow server controller receives remittance information including a remitter's phone number and recipient's recipient information from a remitter terminal, generates an escrow virtual wallet having a one-time escrow virtual wallet address, remits and deposits cryptocurrency corresponding to a remittance amount of the cryptocurrency of the remittance information from a phone number wallet corresponding to the phone number to the one-time escrow virtual wallet address, and generates escrow authentication information including a one-time secure access path and a withdrawal authentication number;
an escrow authentication information provision process, wherein the escrow server controller provides the escrow authentication information including the secure access path and the withdrawal authentication number to the remitter terminal; and
a cryptocurrency withdrawal process, wherein, when the secure access path, the withdrawal authentication number, and a recipient's electronic wallet address from a recipient terminal to receive the cryptocurrency are input, the escrow server controller compares the withdrawal authentication number received from the recipient terminal with the withdrawal authentication number previously set for the one-time escrow virtual wallet corresponding to the secure access path, performs escrow authentication to decrypt the encrypted one-time escrow virtual wallet address with the withdrawal authentication number, and then remits the amount of the cryptocurrency deposited in the one-time escrow virtual wallet address to the recipient's electronic wallet address when escrow authentication is successful.

10. The method of claim 9, wherein the cryptocurrency amount remittance deposit process comprises:
monitoring a service event, wherein the escrow server controller monitors whether a cryptocurrency escrow remittance service event occurs through a service event monitoring part;
determining a transaction type, wherein the escrow server controller determines whether a recipient is a member according to an occurrence of the cryptocurrency escrow remittance service event and determines the transaction type according to a service type between a remitter and the recipient;
receiving the remittance information, wherein, from the remitter terminal through a remittance processing part, the escrow server controller receives the remittance information including the remitter's phone number and recipient's recipient information according to the determined transaction type and the remittance amount to be remitted to an original electronic wallet address corresponding to the cryptocurrency to be remitted and the cryptocurrency; and
depositing the cryptocurrency, wherein the escrow server controller generates the one-time escrow virtual wallet having the one-time escrow virtual wallet address through the remittance processing part, generates the one-time escrow virtual wallet, performs a deposit process of remitting the cryptocurrency corresponding to the remittance amount of the cryptocurrency of the remittance information from the original electronic wallet address corresponding to a coin to be remitted of the phone number wallet to the one-time escrow virtual wallet address, and then generates the escrow authentication information including the one-time secure access path and the withdrawal authentication number.

11. The method of claim 10, wherein, in the determining of the transaction type, the escrow server controller determines any one of a real name transaction between individual members, a recipient identification transaction among the real name transactions between individual members, an anonymous recipient transaction, and a product purchase transaction, according to the remitter information and the recipient information of the received remittance information.

12. The method of claim 11, wherein the cryptocurrency withdrawal process comprises:
processing the real name transaction between individual members, wherein, when the transaction type is the real name transaction between individual members, a real name transaction processing part between individual members generates the escrow virtual wallet having the escrow virtual wallet address applied with a real name recipient code included in the recipient information of the received remittance information, performs the remittance deposit process after generating the escrow virtual wallet, generates the secure access path and the withdrawal authentication number after performing the deposit process, transmits the secure access path and the withdrawal authentication number to the remitter terminal, and then performs the remittance process and withdrawal process;
processing the recipient identification transaction, wherein when the transaction type is the recipient identification transaction among the real name transactions between individual members, the recipient identification transaction processing part performs the remittance deposit process and the remittance process, requests the application program log in according to the recipient identification request when the recipient terminal accesses the escrow virtual wallet address during performing the withdrawal process, receives a payment verification number from the user terminal after logging in as the member of the recipient through the recipient terminal, performs the escrow authentication, and then performs the withdrawal process of remitting a cryptocurrency amount deposited in the escrow virtual wallet address to the recipient's electronic wallet address when the escrow authentication is successful;
processing the anonymous recipient transaction, wherein when the transaction type is the anonymous recipient transaction, the anonymous recipient transaction processing part performs the remittance deposit process by generating the escrow virtual wallet having the escrow virtual wallet address to which an anonymous recipient code included in the received remittance information is applied, generates the secure access path and the withdrawal authentication number, allows the recipient to directly input the electronic wallet address, and then performs the remittance process and withdrawal process; and
processing the purchase transaction, wherein when the transaction type is the product purchase transaction between a buyer and a seller, a purchase transaction processing part performs the remittance deposit process by generating the escrow virtual wallet having the escrow virtual wallet address applied with a real name seller code which is the real name recipient code included in seller information which is the recipient information of the received remittance information, generates and temporarily stores the escrow authentication information including the secure access path and the withdrawal authentication number, writes a transaction detail confirmation form including the cryptocurrency amount deposited as a payment between the buyer as the remitter and the seller as the recipient, information on the transaction party, order information, and delivery check, etc., temporarily stores the transaction detail confirmation form by using an escrow payment transaction number as an access code per case, provides each escrow payment transaction number to the remitter's terminal and the recipient's terminal, confirms product delivery and product receipt according to the escrow payment transaction number, confirms receipt of product, approves the payment when the buyer accesses by the escrow payment transaction number, performs the remittance process in which the escrow authentication information is transmitted only to the seller, and then performs the withdrawal process.

13. The method of claim 12, wherein, the processing of the recipient identification transaction comprises:
requesting application program login, wherein, when the transaction type is the recipient identification transaction among the real name transactions between individual members, after performing the remittance deposit process and the remittance process, the recipient terminal requests application program login according to the recipient identification request when accessing the one-time escrow virtual wallet during performing the withdrawal process;
identifying the recipient, wherein the terminal identification information of the recipient terminal is retrieved when the recipient logs in as the member through the recipient terminal, and the recipient is identified by comparing the obtained recipient's name, telephone number, and extracted terminal identification information with the name, telephone number, and terminal identification information of the recipient's member information; and
withdrawing money, wherein, when the recipient is identified, the one-time withdrawal authentication number is received from the recipient terminal to perform the escrow authentication, and the amount of the cryptocurrency deposited in the one-time escrow virtual wallet address is remitted to the recipient's electronic wallet address when escrow authentication is successful.

14. The method of claim 12, wherein the cryptocurrency withdrawal process further comprises:
deleting the escrow virtual wallet, wherein the escrow server controller deletes the escrow virtual wallet having the one-time escrow virtual wallet address after remitting the cryptocurrency deposited in the one-time escrow virtual wallet, and deletes the escrow authentication information including the one-time secure access path and the withdrawal authentication number.
